SEQUENCE LISTING (15 sequences)

SEQ ID NO: 1 - protein, 269 aa, Bacillus lentus
  REGION 1..269: note = wildtype
AQSVPWGISRVQAPAAHNRGLTGSGVKVAVLDTGISTHPDLNIRGGASFVPGEPSTQDGNGHGTHVAGTIAALNNSIGVLGVAPSAELYAVKVLGADGRGAISSIAQGLEWAGNNGMHVANLSLGSPSPSATLEQAVNSATSRGVLVVAASGNSGASSISYPARYANAMAVGATDQNNNRASFSQYGAGLDIVAPGVNVQSTYPGSTYASLNGTSMATPHVAGAAALVKQKNPSWSNVQIRNHLKNTATSLGSTNLYGSGLVNAEAATR

SEQ ID NO: 2 - protein, 275 aa, Bacillus amyloliquefaciens [sequence omitted]

SEQ ID NO: 3 - protein, 269 aa, synthetic construct
AQSVPWGISRVQAPAAHNRGLTGSGVKVAVLDTGISTHPDLNIRGGASFVPGEPSTQDGNGHGTHVAGTIAALNNSIGVLGVAPSAELYAVKVLGADGEGAISSIAQGLEWAGNNGMHVANLSLGSPSPSATLEQAVNSATSRGVLVVAASGNSGASSISYPARYANAMAVGATDQNNNRASFSQYGAGLDIVAPGVNVQSTYPGSTYASLNGTSMATPHVAGAAALVKQKNPSWSNVQIRNHLKNTATSLGSTNLYGSGLVNAEAATR

SEQ ID NO: 4 - protein, 7 aa, synthetic construct
  REGION 1..7: note = loop sequence
ADGEGAI

SEQ ID NO: 5 - protein, 7 aa, synthetic construct
  REGION 1..7: note = loop sequence
ADGDGAI

SEQ ID NO: 6 - protein, 7 aa, synthetic construct
  REGION 1..7: note = loop sequence
ADGDGSV

SEQ ID NO: 7 - protein, 7 aa, synthetic construct
  REGION 1..7: note = loop sequence
ADGEGSV

SEQ ID NO: 8 - protein, 8 aa, synthetic construct
  REGION 1..8: note = loop sequence
AADGEGSV

SEQ ID NO: 9 - protein, 8 aa, synthetic construct
  REGION 1..8: note = loop sequence
ASEGEGSV

SEQ ID NO: 10 - protein, 4 aa, synthetic construct
AAPF

SEQ ID NO: 11 - protein, 460 aa, synthetic construct
ATGFYVNGNTLYDATGSPFVMRGINHAHSWFKDDSSTAIPAIAKTGANTIRIVLSDGSQYTKDDINTVKSLISLAEKNNLIAILEVHDATGNDAVSSLNDAVSYWISIKEALIGKEDRVLINIANEWYGTWDGASWASGYKQAIPKLRDAGLSHTLIVDSAGWGQYPESIHQYGKDVFNADPLKNTMFSIHMYEYAGGDASTIKSNIDGVLNQDLALIIGEFGHKHTNGDVDEETIMSYSQQKNVGWLAWSWKGNGPEWSYLDLSNDWAGDNLTSWGNTIVNGANGLKATSKISPVFDGGDHPGGSGGTENTLYNFETETQSWSGGNVMAGPWSTNEWASKDNYSLKADVQLNNNSQHYLSLTQNQNFSGKSQLKATVKHADWGNLGNGINAQLYVKTGSDWKWFDGESVEINSSNGTILTLDLSSISDLNDIKEIGVQFMGSSKSSGQTAVYVDNVTIQ

SEQ ID NO: 12 - protein, 460 aa, synthetic construct
ATGFYVNGNTLYDATGSPFVMRGINHAHSWFKDDSSTAIPAIAKTGANTIRIVLSDGSVYTKDDIDTVKSLISLAEKNNLIAILEVHDHTGNDAVSSLNDAVSYWISIKEALIGKEDRVLINIANEWYGTWDGASWASGYKQAIPKLRDAGLSHTLIVDSAGWGQYPESIHQYGKDVFNADPLKNTMFSIHMYEYAGGDASTIKSNIDGVLNQDLALIIGEFGHKHTNGDVDEQTIMSYSQQKNVGWLAWSWKGNGPEMSYLDLSNDWAGDNLTSWGNTIVYGANGLKATSKISPVFDGGDHPGGSGGTENTLYNFENGTQGWSGGNVMAGPWSTNEWASKDNYSLKADVQLNNNSQHYLSLTQNQNFSGKSQLKATVKHADWGNLGNGINAQLYVKTGSDWKWFDGESVEINSSNGTILTLDLSSISDLNDIKEIGVQFMGSSKSSGQTAVYVDNVTIQ

SEQ ID NO: 13 - protein, 298 aa, synthetic construct
MATGFYVSGNKLYDSTGKEFVMRGVNHGHTWFKNDLNEAIPAIAKTGANTVRIVLSNGVQYTRDDLDAVKNIINVVNQNKMIAVLEVHDATGKDDYDSLDAAINYWISIKEALIGKEDRVIVNIANEWMGTWNGSAWADGYKKAIPKLRNAGIKNTLIVDAAGWGQYPQSIVDYGQSVFAADSLKNTVFSIHMYEYAGKDAATVKANMENVLNKGLALIIGEFGCYHVNGDVDELAIMRYGQELGVGWLAWSWYGNSDGLRYLDMATGPNGSLTSFGNTVVNDTYGIKNTSQKAGIFQ

SEQ ID NO: 14 - protein, 483 aa, synthetic construct
HHNGTNGTMMQYFEWYLPNDGNHWNRLRSDASNLKDKGITAVWIPPAWKGASQNDVGYGAYDLYDLGEFNQKGTVRTKYGTRNQLQAAVTALKSNGIQVYGDVVMNHKGGADATEWVRAVEVNPSNRNQEVSGDYTIEAWTKFDFPGRGNTHSNFKWRWYHFDGVDWDQSRQLQNRIYKFRGKGWDWEVDTENGNYDYLMYADIDMDHPEVVNELRNWGVWYTNTLGLDGFRIDAVKHIKYSFTRDWLTHVRNTTGKNMFAVAEFWKNDIGAIENYLSKTNWNHSVFDVPLHYNLYNASRSGGNYDMRQIFNGTVVQRHPTHAVTFVDNHDSQPEEALESFVEEWFKPLAYALTLTRDQGYPSVFYGDYYGIPTHGVPAMKSKIDPILEARQKYAYGTQRDYLDHPDVIGWTREGDGVHADSGLATLMSDGPGGSKWMEVGKNNAGEVWYDITGNQTNTVTINKDGWGQFHVSGGSVSIYVQQ

SEQ ID NO: 15 - protein, 485 aa, synthetic construct
HHNGTNGTMMQYFEWYLPNDGNHWNRLRSDASNLKDKGITAVWIPPAWKGASQNDVGYGAYDLYDLGEFNQKGTVRTKYGTRNQLQAAVTALKSNGIQVYGDVVMNHKGGADATEWVRAVEVNPSNRNQEVSGDYTIEAWTKFDFPGRGNTHSNFKWRWYHFDGVDWDQSRQLQNRIYKFRGDGKGWDWEVDTENGNYDYLMYADIDMDHPEVVNELRNWGVWYTNTLGLDGFRIDAVKHIKYSFTRDWLTHVRNTTGKNMFAVAEFWKNDIGAIENYLSKTNWNHSVFDVPLHYNLYNASRSGGNYDMRQIFNGTVVQRHPTHAVTFVDNHDSQPEEALESFVEEWFKPLAYALTLTRDQGYPSVFYGDYYGIPTHGVPAMKSKIDPILEARQKYAYGKQNDYLDHHNMIGWTREGNTAHPNSGLATIMSDGPGGNKWMYVGRNKAGQVWRDITGNRSGTVTINADGWGNFSVNGGSVSIWVNN

(19) United States
(12) Patent Application Publication
(10) Pub. No.: US 2026/0185016 A1
(43) Pub. Date: Jul. 2, 2026

(54) CLEANING COMPOSITIONS COMPRISING A MANNANASE

(71) Applicant: BASF SE, Ludwigshafen (DE)

(72) Inventors: Veronique STARCK, Ludwigshafen am Rhein (DE); Gerhard WIEBE, Ludwigshafen am Rhein (DE); Janina BERNDT, Ludwigshafen am Rhein (DE); Oliver SPANGENBERG, Ludwigshafen am Rhein (DE); Claudia ESPER, Ludwigshafen am Rhein (DE)

(21) Appl. No.: 19/347,898

(22) Filed: Oct. 2, 2025

(30) Foreign Application Priority Data
Oct. 2, 2024 (EP) 24204269.5

(51) Int. Cl. C11D 3/386; C11D 1/72; C11D 1/74; C11D 1/825

(52) U.S. Cl. CPC C11D 3/38636; C11D 1/72; C11D 1/74; C11D 1/825

(57) ABSTRACT

Described herein are cleaning compositions comprising a mannanase. In addition, described herein are methods of making the cleaning compositions and using the cleaning compositions for having an improved storage stability.

### CROSS-REFERENCE TO RELATED APPLICATIONS

This application claims priority to European Patent Application No. 24204269.5, filed Oct. 2, 2024, each of which is hereby incorporated by reference herein.

### REFERENCE TO AN ELECTRONIC SEQUENCE LISTING

The contents of the electronic sequence listing (240759_sequence_listing.xml; Size: 19,200 bytes; and Date of Creation: Aug. 4, 2025) are herein incorporated by reference in their entirety.

### FIELD OF THE INVENTION

In the present invention liquid cleaning compositions comprising a mannanase are provided. In addition, methods of making the cleaning compositions and using the cleaning compositions for improving the storage stability are provided.

### BACKGROUND OF THE INVENTION

Enzymes are increasingly used in cleaning compositions. Enzymes are biodegradable and can be catalytically active already at lower temperatures, which results in reduction of energy consumption during cleaning.

Mannanases are enzymes capable of hydrolyzing mannan. Thus, mannanases have been employed in the removal of mannan-containing stains and have been added to cleaning compositions for this purpose. However, in cleaning compositions, mannanase are often unstable and tend to denature upon storage of the mannanase-containing cleaning composition leading to a reduction of wash performance over time. Mannanase stability in cleaning compositions highly depends on the interaction of the mannanase with the detergent components. Thus, mannanase stability in cleaning compositions depends on the mannanase itself as well as the specific composition of the cleaning composition.

WO 2021/133701 A1 (PROCTER & GAMBLE [US]) discloses cleaning compositions comprising a DNase with at least 60% sequence identity to SEQ ID NO: 1, an additional enzyme selected from mannanases, amylases, cellulases, lipases, proteases, and mixtures thereof, and a cleaning adjunct preferably comprising a surfactant.

WO 2024/050339 A1 (DANISCO US INC [US]) discloses a mannanase variant with amino acid substitutions at positions 32, 72, 161, and 172 and includes model detergent formulations containing these mannanase variants.

WO 99/64619 A2 (NOVO NORDISK AS [DK]; KAUPPINEN MARKUS SAKARI [DK] ET AL.) discloses mannanases with SEQ ID NO: 2, SEQ ID NO: 6, and SEQ ID NO: 8, having various mutations, and detergent formulations containing these mannanases.

The inventors of the present application identified that the use of a particular type of mannanase in combination with specific detergent components results in a cleaning composition that has improved mannanase stability during storage of the cleaning composition.

### BRIEF SUMMARY OF THE INVENTION

The present invention is directed to a liquid cleaning composition comprising
a) a surfactant composition characterized in that the weight ratio of the total amount of all non-ionic surfactants (NIO) to the total amount of all surfactants in the cleaning composition is equal or below 0.88 times the weight ratio of the total amount of all alkyl benzene sulfonates (AS) to the total amount of all surfactants in the cleaning composition minus 0.1, wherein the weight ratio of the total amount of all AS to the total amount of all surfactants in the cleaning composition is greater 0.1136, and
b) a mannanase variant comprising
   b1) one or more amino acid substitutions at positions selected from the group consisting of 59, 66, 89, 234, 259, 282, 318, 319, and 322, according to the numbering of SEQ ID NO: 11, and an amino acid sequence which is at least 65%, preferably at least 70%, but less than 100% identical to SEQ ID NO: 11, or
   b2) one or more amino acid substitutions at positions selected from the group consisting of 59, 66, 89, 234, 259, and 282, according to the numbering of SEQ ID NO: 11, and an amino acid sequence which is at least 65%, preferably at least 70%, but less than 100% identical to amino acids 1-296 of SEQ ID NO: 11.

The present invention is further directed to a method of making such cleaning composition and to the use of such cleaning composition for improving the storage stability of the mannanase variant in the cleaning composition and for improving the wash performance of the cleaning composition after storage.

### DETAILED DESCRIPTION OF THE INVENTION

The present invention may be understood more readily by reference to the following detailed description of the embodiments described herein and the examples included herein. Although the present invention will be described with respect to particular embodiments, this description is not to be construed in a limiting sense.

### Definitions

Unless otherwise noted, the terms used herein are to be understood according to conventional usage by those of ordinary skill in the relevant art.

Before describing in detail exemplary embodiments of the present invention, definitions important for understanding the present invention are given. Unless stated otherwise or apparent from the nature of the definition, the definitions apply to all compounds, methods and uses described herein.

As used in this specification and in the appended claims, the singular forms of “a” and “an” also include the respective plurals unless the context clearly dictates otherwise.

In the context of the present invention, the terms “about” and “approximately” denote an interval of accuracy that a person skilled in the art will understand to still ensure the technical effect of the feature in question. The term typically indicates a deviation from the indicated numerical value of ±20%, preferably ±15%, more preferably ±10%, and even more preferably ±5%.

Furthermore, the terms “first”, “second”, “third” or “(a)”, “(b)”, “(c)”, “(d)” etc. and the like in the description and in the claims, are used for distinguishing between similar elements and not necessarily for describing a sequential or chronological order. It is to be understood that the terms so used are interchangeable under appropriate circumstances and that the embodiments described herein are capable of operation in other sequences than described or illustrated herein. In case the terms “first”, “second”, “third” or “(a)”, “(b)”, “(c)”, “(d)”, “i”, “il” etc. relate to steps of a method or use or assay there is no time or time interval coherence between the steps, i.e. the steps may be carried out simultaneously or there may be time intervals of seconds, minutes, hours, days, weeks, months or even years between such steps, unless otherwise indicated in the application as set forth herein above or below. Throughout this application, various publications are referenced. The disclosure of all of these publications and those references cited within those publications in their entireties are hereby incorporated by reference into this application in order to more fully describe the state of the art to which this invention pertains.

It is to be understood that the term “comprising” is not limiting. For the purposes of the present invention the term “consisting of” is considered to be a preferred embodiment of the term “comprising”. If hereinafter a group is defined to comprise at least a certain number of members, this is meant to also encompass a group which consists of these members only.

“Amino acid substitutions” are described by providing the original amino acid followed by the number of the position within the amino acid sequence, followed by the substituted amino acid. For example, the substitution of histidine at position 120 with alanine is designated as “His120Ala” or “H120A”. Substitutions can also be described by merely naming the resulting amino acid in the variant without specifying the amino acid of the parent at this position, e.g., by using “X120A” or “120A” or “Xaa120Ala” or “120Ala”.

Variants comprising multiple substitutions are separated by “+”, e.g., “Arg170Tyr+Gly195Glu”, “R170Y+G195E” or “X170Y+X195E” representing a substitution of arginine and glycine at positions 170 and 195 with tyrosine and glutamic acid, respectively. Alternatively, multiple substitutions may be separated by space or a comma, e.g., “R170Y G195E” or “R170Y, G195E” respectively. Where different alternative substitutions can be introduced at a position, the different substitutions are separated by a comma, e.g., “Arg170Tyr,Glu” and “R170T,E”, respectively, represents a substitution of arginine at position 170 with tyrosine or glutamic acid. Alternative substitutions at a particular position can also be indicated as “X120A,G,H”, “120A,G,H”, “X120A/G/H”, or “120A/G/H”. Alternatively, different substitutions may be indicated in brackets, e.g., “Arg170 [Tyr, Gly]” or “Arg170 {Tyr, Gly}” or in short “R170 [Y,G]” or “R170 {Y,G}”.

Variant polynucleotide and variant polypeptide sequences may be defined by their sequence identity when compared to a parent sequence. Sequence identity usually is provided as “% sequence identity” or “% identity”. For calculation of sequence identities, in a first step a sequence alignment is produced. According to this invention, a pairwise global alignment is produced, meaning that two sequences are aligned over their complete length, which is usually produced by using a mathematical approach, called alignment algorithm.

According to the invention, the alignment is generated by using the algorithm of Needleman and Wunsch (J. Mol. Biol. (1970) 48, p. 443-453). Preferably, the program “NEEDLE” (The European Molecular Biology Open Software Suite (EMBOSS)) is used for the purposes of the current invention, with using the programs default parameter (polynucleotides: gap open=10.0, gap extend=0.5 and matrix=EDNAFULL; polypeptides: gap open=10.0, gap extend=0.5 and matrix=EBLOSUM62). After aligning two sequences, in a second step, an identity value is determined from the alignment produced. For this purpose, the %-identity is calculated by dividing the number of identical residues by the length of the alignment region which is showing the respective sequence of the present invention over its complete length multiplied with 100: %-identity=(identical residues/length of the alignment region which is showing the respective sequence of the present invention over its complete length)*100.

A special aspect concerning amino acid substitutions are conservative mutations which often appear to have a minimal effect on protein folding resulting in substantially maintained enzyme properties of the respective enzyme variant compared to the enzyme properties of the parent enzyme. Conservative mutations are those where one amino acid is exchanged with a similar amino acid. Such an exchange most probably does not change enzyme properties. Herein the following conservative exchanges are considered:
Amino acid A is similar to amino acids S
Amino acid D is similar to amino acids E; N
Amino acid E is similar to amino acids D; K; Q
Amino acid F is similar to amino acids W; Y
Amino acid H is similar to amino acids N; Y
Amino acid I is similar to amino acids L; M; V
Amino acid K is similar to amino acids E; Q; R
Amino acid L is similar to amino acids I; M; V
Amino acid M is similar to amino acids I; L; V
Amino acid N is similar to amino acids D; H; S
Amino acid Q is similar to amino acids E; K; R
Amino acid R is similar to amino acids K; Q
Amino acid S is similar to amino acids A; N; T
Amino acid T is similar to amino acids S
Amino acid V is similar to amino acids I; L; M
Amino acid W is similar to amino acids F; Y
Amino acid Y is similar to amino acids F; H; W

Conservative amino acid substitutions may occur over the full length of the sequence of a polypeptide sequence of a functional protein such as an enzyme. Preferably, such mutations are not pertaining the functional domains of an enzyme, more preferably conservative mutations are not pertaining the catalytic centers of an enzyme. “Protein formulation” (or “enzyme preparation” or “polypeptide formulation”), e.g., “protease formulation”, means any non-complex formulation comprising a small number of ingredients, preferably, 2-6 components, wherein the ingredients serve the purpose of stabilizing the proteins comprised in the protein formulation and/or the stabilization of the protein formulation itself. Preferably, the non-complex protein formulation comprises the protein in higher concentrations than the complex formulation, e.g., than a detergent formulation. Thus, preferably the non-complex protein formulation is a concentrated protein formulation. Preferably, non-complex protein formulations comprise 20 to 120 mg/g active enzyme, whereas complex formulations, like cleaning compositions, comprise 0.002 to 10 mg/g active enzyme. In contrast to a non-complex formulation, a complex formulation means herein a formulation comprising a higher number of ingredients, preferably, 7-30 components, wherein the ingredients serve the purpose of stabilizing the proteins comprised in the protein formulation and/or the stabilization of the protein formulation itself, but additionally the complex formulation comprises components that serve the purpose of the complex formulation, e.g., a cleaning composition. An example for a non-complex protein formulation is a concentrated enzyme composition that is used as a stock-solution to prepare a complex formulation, e.g., a cleaning composition, wherein in the cleaning compositions other compounds are present that serve the cleaning purpose of the cleaning composition, e.g., surfactants and/or chelating agents.

A “liquid” composition has a physical form that is not solid or gas. A “liquid” composition has a definite volume but no a definite shape. This means that a liquid will take on the shape of the container it is placed in, but the amount of space it takes up will not change. Unlike gases, liquids are not easily compressible and have a higher density. Thus, liquid compositions include gel-type compositions. An “aqueous liquid” composition is a composition in which more than 50 weight % of the sum of all solvents is water.

“Enzyme properties” include, but are not limited to, catalytic activity, substrate/cofactor specificity, product specificity, stability in the course of time, thermostability, pH stability, and chemical stability. “Enzymatic activity” or “catalytic activity” means the catalytic effect exerted by an enzyme, expressed as units per milligram of enzyme (specific activity) or molecules of substrate transformed per minute per molecule of enzyme (molecular activity). Enzymatic activity can be specified by the enzyme's actual function, e.g., proteases exerting proteolytic activity by catalyzing hydrolytic cleavage of peptide bonds, lipases exerting lipolytic activity by hydrolytic cleavage of ester bonds, amylases activity involves hydrolysis of glycosidic linkages in polysaccharides, etc.

The term “enzyme stability” according to the current invention relates to the retention of enzymatic cleaning performance as a function of time during storage or operation. Retention of enzymatic cleaning performance as a function of time during storage is called “storage stability”.

To determine and quantify changes in enzymatic cleaning performance of enzymes stored under certain conditions over time, the enzymatic cleaning performance is measured as described herein in the examples, preferably compared to a cleaning composition comprising a different mannanase and/or compared to a cleaning composition comprising a different surfactant composition. Preferably, enzymatic cleaning performance is measured after storage of the cleaning composition comprising the mannanase at 37° C. for 56 days.

“Enzyme inhibitors” as used herein are compounds that slow down or halt enzymatic activity. Enzyme inhibitors frequently also stabilize the enzyme in its three-dimensional structure. Hence, enzyme inhibitors usually also act as “enzyme stabilizers”.

The term “detergent stability” (also called herein “residual activity in a detergent”, or “residual enzymatic wash performance”, or “storage stability in a cleaning composition”) refers to the ability of an enzyme to exert cleaning performance after storage in a cleaning composition, preferably, at a temperature of 15° C., 30° C., 37° C., 45° C., or 50° C. for up to 86 days in a cleaning composition (preferably, in any of the cleaning compositions F6, F7, F8, F10, F11, F12, F13, and F14 shown in Table 1). Most preferably, detergent stability is determined by measuring enzyme stability of the protease after storage at a temperature of at 37° C. for 56 days in a cleaning composition as described herein.

As used herein, “wash performance” (also called herein “cleaning performance”) of an enzyme refers to the contribution of the enzyme to the cleaning performance of a cleaning composition, i.e. the cleaning performance added to the cleaning composition by the performance of the enzyme. The term “wash performance” is used herein similarly for laundry and hard surface cleaning. Wash performance is compared under relevant washing conditions. Preferably, wash performance is measured as described herein in the examples, preferably compared to a cleaning composition comprising a different mannanase and/or compared to a cleaning composition comprising a different surfactant composition. The term “relevant washing conditions” is used herein to indicate the conditions, particularly washing temperature, time, washing mechanics, sud concentration, type of detergent and water hardness, actually used in households in a detergent market segment. The term “improved wash performance” is used to indicate that a better end result is obtained in stain removal under relevant washing conditions, or that less enzyme, on weight basis, is needed to obtain the same end result relative to the corresponding control conditions.

As used herein, the term “specific performance” refers to the cleaning and removal of specific stains or soils per unit of active enzyme. In some embodiments, the specific performance is determined using stains or soils such as egg, egg yolk, milk, grass, minced meat blood, chocolate sauce, baby food, sebum, etc.

The terms “cleaning composition” (also called herein “cleaning formulation”, “detergent composition”, “detergent formulation” or “detergent”) as used herein includes compositions and formulations designed for cleaning soiled material. Such compositions and formulations include those designed for cleaning soiled material or surfaces of any kind. Cleaning compositions can be for industrial and institutional cleaning or for fabric and home care.

Compositions for “industrial and institutional cleaning” includes such cleaning compositions being designed for use in industrial and institutional cleaning, such as those for use of cleaning soiled material or surfaces of any kind, such as hard surface cleaners for surfaces of any kind, including tiles, carpets, PVC-surfaces, wooden surfaces, metal surfaces, lacquered surfaces.

“Compositions for fabric and home care” include cleaning compositions and formulations including but not limited to laundry cleaning compositions and detergents, fabric softening compositions, fabric enhancing compositions, fabric freshening compositions, laundry prewash, laundry pretreat, laundry additives, spray products, dry cleaning agent or composition, laundry rinse additive, wash additive, post-rinse fabric treatment, ironing aid, dish washing compositions, hard surface cleaning compositions, unit dose formulation, delayed delivery formulation, detergent contained on or in a porous substrate or nonwoven sheet, and other suitable forms that may be apparent to one skilled in the art in view of the teachings herein and detailed herein below when describing the compositions. Such compositions may be used as a pre-laundering treatment, a post-laundering treatment, or may be added during the rinse or wash cycle of the laundering operation, preferably during the wash cycle of the laundering or dish washing operation, and as further detailed herein below when describing the use and application of the inventive compound(s) and compositions comprising such polymers.

Cleaning compositions are complex formulations as further defined herein. Cleaning compositions according to the invention include cleaning compositions for different applications such as laundry and hard surface cleaning. Cleaning compositions according to the invention also include biodegradable cleaning compositions. Cleaning compositions according to the invention are composed of several adjunct cleaning additives.

Cleaning compositions are further described in Reference RF1 and Reference RF2, in particular in paragraphs [0004] and [0007] of Reference RF1.

The publication IPCOM000274907D concerning cleaning compositions published on www.IP.com is regarded as Reference RF1, which is incorporated herein by reference in its entirety. The publication Prior Art Disclosure; Issue 684; paragraphs [3000] to [3061]; ISSN: 2198-4786; published: Feb. 12, 2024 also concerning cleaning compositions will be regarded as Reference RF2, which is incorporated herein by reference in its entirety.

The term “adjunct cleaning additive” is defined herein to mean a type of chemical, which can be used in cleaning compositions. A typical adjunct cleaning additive is a surfactant. “Surfactant” means an organic chemical that is not a soap and when added to a liquid, changes the properties of that liquid at an interface. According to its ionic charge, a surfactant is called non-ionic, anionic, cationic, zwitterionic, or amphoteric. A “surfactant composition” refers to the totality of all surfactants in the cleaning composition not including soaps. “Soaps” are understood herein as salts of saturated and unsaturated C12-C18 fatty acids.

The term “effective amount of an adjunct cleaning additive” includes amounts of certain components to provide effective stain removal and/or effective cleaning conditions (e.g. pH, temperature, water hardness, quantity of foaming), amounts of certain components to effectively provide optical benefits (e.g. optical brightening, dye transfer inhibition, color care), and amounts of certain components to effectively aid the processing (maintain physical characteristics during processing, storage and use; e.g. rheology modifiers, hydrotropes, desiccants).

The term “laundry” or “laundering” relates to both household laundering and industrial laundering and means the process of treating textiles and/or fabrics with a solution containing a cleaning composition. The laundering process may be carried out by using technical devices such as a household or an industrial washing machine. Alternatively, the laundering process may be done by hand.

The term “textile” means any textile material including yarns (thread made of natural or synthetic fibers used for knitting or weaving), yarn intermediates, fibers, non-woven materials, natural materials, synthetic materials, as well as fabrics made of these materials such as garments, cloths and other articles. The terms “fabric” refers to a textile made by weaving, knitting or felting fibers. The term “garment” refers to any article of clothing made of textile.

The term “fibers” includes natural fibers, synthetic fibers, and mixtures thereof. Examples of natural fibers are of plant (such as flax, jute and cotton) or animal origin, comprising proteins like collagen, keratin and fibroin (e.g. silk, sheep's wool, angora, mohair, cashmere). Examples for fibers of synthetic origin are polyurethane fibers such as Spandex® or Lycra®, polyester fibers, polyolefins such as elastofin, or polyamide fibers such as nylon. Fibers may be single fibers or parts of textiles such as knitwear, woven or non-woven fabrics.

The term “hard surface cleaning” relates to both household hard surface cleaning and industrial hard surface cleaning and means the process of treating hard surfaces with a solution containing a cleaning composition. Hard surfaces may include any hard surfaces in the household or industry, such as floors, furnishing, walls, sanitary ceramics, glass, metallic surfaces including cutlery or dishes and medical devices such as diagnostic instruments, trays, pans, holders, racks, forceps, scissors, shears, saws (e.g. bone saws and their blades), hemostats, knives, chisels, rongeurs, files, nippers, drills, drill bits, rasps, burrs, spreaders, breakers, elevators, clamps, needle holders, carriers, clips, hooks, gouges, curettes, retractors, straightener, punches, extractors, scoops, keratomes, spatulas, expressors, trocars, dilators, cages, glassware, tubing, catheters, cannulas, plugs, stents, endoscopes, arthoscopes and related equipment. A particular form of hard surface cleaning is dishwashing, particularly automatic dishwashing (ADW).

The term “dish wash” refers to all forms of washing dishes, e.g. by hand or automatic dish wash. Washing dishes includes, but is not limited to, the cleaning of all forms of crockery such as plates, cups, glasses, bowls, all forms of cutlery such as spoons, knives, forks and serving utensils as well as ceramics, plastics such as melamine, metals, china, glass and acrylics.

The term “medical device cleaning” refers to the cleaning step in reprocessing reusable medical devices. Medical device cleaning methods can be divided into two categories, manual and mechanical/automated cleaning methods. Manual cleaning is used when mechanical units are not available or medical devices to be cleaned are too fragile or difficult to clean with a mechanical unit. Mechanical/automated cleaning methods remove soiling and microorganisms through an automated cleaning and rinsing process, this includes ultrasonic cleaning and washing. In the field of detergency, usually the term “stains” is used with reference to laundry, e.g., cleaning of textiles, fabric, or fibers, whereas the term “soils” is usually used with reference to hard surface cleaning, e.g., cleaning of dishes and cutlery. However, herein the terms “stain” and “soil” shall be used interchangeably.

“Builders” (also called “complexing agent”, “chelating agent”, or “chelator”) are chemical compounds capable of binding cations, in particular magnesium and calcium cations. A “builder composition” refers to the totality of all builders in the cleaning composition and is a mixture of at least two different builders.

A “sequestering builder” as used herein is different from a precipitating builder in that no significant amount of precipitate is formed when the builder is used in an amount sufficient to combine with all of the calcium ions in an aqueous solution with 7° dH hardness (German hardness) initially at neutral pH. A “strong builder” is classified as high efficiency chelator that can bind the divalent cations such as Ca2+ strongly with a logarithmic stability constant (Log K_{Ca}) of the cation/chelator complex of above 4, particular above 5, above 6 or above 7. The stability constants are determined at an ionic strength of 0.1 M and at a temperature of 25° C. A “strong sequestering builder” combines both of the above-mentioned properties. Further details on strong/weak and sequestering/precipitating builders are provided in paragraphs to of EP2989117B1, which are incorporated herein by reference.

A “biodegradable” compound (such as a surfactant or complexing agent) is a compound that is readily biodegradable in an aerobic aqueous medium according to the OECD guideline 301. “Readily biodegradable” is defined according to the Detergents Regulation as the ability of a product to biodegrade more than 60% within 28 days according to OECD 301A-F/ASTM.

The term “effective amount of a detergent component” includes amounts of certain components to provide effective stain removal and/or effective cleaning conditions (e. g. pH, temperature, water hardness, quantity of foaming), amounts of certain components to effectively provide optical benefits (e. g. optical brightening, dye transfer inhibition, color care), and amounts of certain components to effectively aid the processing (maintain physical characteristics during processing, storage and use; e.g. rheology modifiers, hydrotropes, desiccants).

A composition “essentially devoid” of a compound shall mean herein that the respective compound is not added to the composition on purpose, meaning that at most non-effective amounts are present, most preferably 0% of the compound are contained in the composition.

### Detailed Description

Herein, new cleaning compositions are provided, which have beneficial properties.

### Cleaning Compositions

Specifically, the present invention is directed to a cleaning composition comprising an effective amount of a mannanase variant and a surfactant composition as described herein. As understood herein, the cleaning composition is a complex formulation as described herein.

### Mannanase Variant

“Mannanases” as described herein are enzymes selected from the group of mannan degrading enzymes that according to the invention have “mannanase activity”. The mannan degrading enzyme according to the invention is selected from the group of endo-1,4-β-mannosidases (EC 3.2.1.78), a group of enzymes which may be called endo-β-1,4-D-mannanase, β-mannanase, or mannanase herein. “Mannanase activity” describes the capability of β-mannanases to degrade mannans by hydrolysis of the internal glycoside bonds in the mannan backbone. Since mannanases degrade the mannan backbone, they are capable of degrading mannans, galactomannans and/or glucomannans.

Mannanase activity may be determined by assays for measurement of mannanase activity, which are known to those skilled in the art. For instance, a mannanase to be tested may be applied to 4 mm diameter holes punched out in agar plates comprising 0.2% AZCL galactomannan (carob), i.e. substrate for the assay of endo-1,4-beta-D-mannanase. Carob is e.g. available as I-AZGMA from the company Megazyme. Mannan degrading activity may be tested in a liquid assay using carob galactomannan dyed with Remazol Brilliant Blue as described in McCleary, B. V. 10 (1978). Carbohydrate Research, 67 (1), 213-221. Another method for testing mannan degrading activity uses detection of reducing sugars when incubated with substrate such as guar gum or locust bean gum—for reference see Miller, G. L. Use of Dinitrosalicylic Acid Reagent for Determination of Reducing Sugars. Analytical Chemistry 1959; 31:426-428.

The mannanase of the cleaning composition is a mannanase variant that comprises an amino acid sequence which is at least 65%, preferably at least 70%, but less than 100% identical to SEQ ID NO: 11.

In one embodiment, the mannanase is a variant of a parent mannanase, wherein the mannanase variant comprises one or more amino acid substitutions at positions selected from the group consisting of 59, 66, 89, 234, 259, 282, 318, 319, and 322, according to the numbering of SEQ ID NO: 11, and an amino acid sequence which is at least 65%, preferably at least 70%, at least 75%, at least 80%, at least 85%, at least 90%, at least 91%, at least 92%, at least 93%, at least 94%, at least 95%, at least 96%, at least 97%, or even more preferably at least 98% but less than 100% identical SEQ ID NO: 11. Preferably, the mannanase variant comprises amino acid substitutions at positions 234 and/or 282 according to the numbering of SEQ ID NO: 11, and an amino acid sequence which is at least 65%, preferably at least 70%, at least 75%, at least 80%, at least 85%, at least 90%, at least 91%, at least 92%, at least 93%, at least 94%, at least 95%, at least 96%, at least 97%, or even more preferably at least 98% but less than 100% identical SEQ ID NO: 11.

In another embodiment, the mannanase is a variant of a parent mannanase that comprises at least one, at least two, at least three, at least four, at least five, at least six, at least seven, at least eight or all amino acid substitutions selected from the group consisting of X59V, X66D, X89H, X234Q, X259M, X282Y, X318N, X319G, and X322G according to the numbering of SEQ ID NO: 11 and an amino acid sequence which is at least 65%, preferably at least 70%, at least 75%, at least 80%, at least 85%, at least 90%, at least 91%, at least 92%, at least 93%, at least 94%, at least 95%, at least 96%, at least 97%, or even more preferably at least 98% but less than 100% identical SEQ ID NO: 11. Preferably, the mannanase variant comprises the amino acid substitutions X234Q and/or X282Y according to the numbering of SEQ ID NO: 11 and an amino acid sequence which is at least 65%, preferably at least 70%, at least 75%, at least 80%, at least 85%, at least 90%, at least 91%, at least 92%, at least 93%, at least 94%, at least 95%, at least 96%, at least 97%, or even more preferably at least 98% but less than 100% identical SEQ ID NO: 11.

In another embodiment, the mannanase is a variant of a parent mannanase that comprises at least one, at least two, at least three, at least four, at least five, at least six, at least seven, at least eight or all amino acid substitutions selected from the group consisting of X59V, X66D, X89H, X234Q, X259M, X282Y, X318N, X319G, and X322G according to the numbering of SEQ ID NO: 11 and an amino acid sequence which is at least 90%, preferably at least 91%, at least 92%, at least 93%, at least 94%, at least 95%, at least 96%, at least 97%, or even more preferably at least 98% but less than 100% identical SEQ ID NO: 11.

In another embodiment, the mannanase is a variant of a parent mannanase that comprises at least one, at least two, at least three, at least four, at least five, at least six, at least seven, at least eight or all amino acid substitutions selected from the group consisting of Q59V, N66D, A89H, E234Q, W259M, N282Y, T318N, E319G, and S322G according to the numbering of SEQ ID NO: 11 and an amino acid sequence which is at least 65%, preferably at least 70%, at least 75%, at least 80%, at least 85%, at least 90%, at least 91%, at least 92%, at least 93%, at least 94%, at least 95%, at least 96%, at least 97%, or even more preferably at least 98% but less than 100% identical SEQ ID NO: 11. Preferably, the mannanase variant comprises the amino acid substitutions E234Q and/or N282Y according to the numbering of SEQ ID NO: 11 and an amino acid sequence which is at least 65%, preferably at least 70%, at least 75%, at least 80%, at least 85%, at least 90%, at least 91%, at least 92%, at least 93%, at least 94%, at least 95%, at least 96%, at least 97%, or even more preferably at least 98% but less than 100% identical SEQ ID NO: 11.

The mannanase variant may comprise one or more, preferably 1-10, more preferably 1-5 conservative amino acid substitutions. Thus, in one embodiment, the mannanase is a variant comprising or consisting of SEQ ID NO: 11 with the amino acid substitutions Q59V, N66D, A89H, E234Q, W259M, N282Y, T318N, E319G, and S322G according to the numbering of SEQ ID NO: 11 and optionally additionally comprises one or more, preferably 1-10, more preferably 1-5 conservative amino acid substitutions.

In another embodiment, the mannanase consists of SEQ ID NO: 11 with the amino acid substitutions Q59V, N66D, A89H, E234Q, W259M, N282Y, T318N, E319G, and S322G according to the numbering of SEQ ID NO: 11 and optionally additionally comprises one or more, preferably 1-10, more preferably 1-5 conservative amino acid substitutions.

In one embodiment, the mannanase is a variant of a parent mannanase, wherein the mannanase variant comprises one or more amino acid substitutions at positions selected from the group consisting of 59, 66, 89, 234, 259, and 282, according to the numbering of SEQ ID NO: 1, and an amino acid sequence which is at least 65%, preferably at least 70%, at least 75%, at least 80%, at least 85%, at least 90%, at least 91%, at least 92%, at least 93%, at least 94%, at least 95%, at least 96%, at least 97%, or even more preferably at least 98% but less than 100% identical to amino acids 1-296 of SEQ ID NO: 11. Preferably, the mannanase variant comprises amino acid substitutions at positions 234 and/or 282, according to the numbering of SEQ ID NO: 1, and an amino acid sequence which is at least 65%, preferably at least 70%, at least 75%, at least 80%, at least 85%, at least 90%, at least 91%, at least 92%, at least 93%, at least 94%, at least 95%, at least 96%, at least 97%, or even more preferably at least 98% but less than 100% identical to amino acids 1-296 of SEQ ID NO: 11.

In another embodiment, the mannanase is a variant of a parent mannanase that comprises at least one, at least two, at least three, at least four, at least five, or all amino acid substitutions selected from the group consisting of X59V, X66D, X89H, X234Q, X259M, and X282Y according to the numbering of SEQ ID NO: 11 and an amino acid sequence which is at least 65%, preferably at least 70%, at least 75%, at least 80%, at least 85%, at least 90%, at least 91%, at least 92%, at least 93%, at least 94%, at least 95%, at least 96%, at least 97%, or even more preferably at least 98% but less than 100% identical to amino acids 1-296 of SEQ ID NO: 11. Preferably, the mannanase variant comprises the amino acid substitutions X234Q and/or X282Y according to the numbering of SEQ ID NO: 11 and an amino acid sequence which is at least 65%, preferably at least 70%, at least 75%, at least 80%, at least 85%, at least 90%, at least 91%, at least 92%, at least 93%, at least 94%, at least 95%, at least 96%, at least 97%, or even more preferably at least 98% but less than 100% identical to amino acids 1-296 of SEQ ID NO: 11.

In another embodiment, the mannanase is a variant of a parent mannanase that comprises at least one, at least two, at least three, at least four, at least five, or all amino acid substitutions selected from the group consisting of X59V, X66D, X89H, X234Q, X259M, and X282Y according to the numbering of SEQ ID NO: 11 and an amino acid sequence which is at least 90%, preferably at least 91%, at least 92%, at least 93%, at least 94%, at least 95%, at least 96%, at least 97%, or even more preferably at least 98% but less than 100% identical to amino acids 1-296 of SEQ ID NO: 11.

In another embodiment, the mannanase is a variant of a parent mannanase that comprises at least one, at least two, at least three, at least four, at least five, or all amino acid substitutions selected from the group consisting of Q59V, N66D, A89H, E234Q, W259M, and N282Y according to the numbering of SEQ ID NO: 11 and an amino acid sequence which is at least 65%, preferably at least 70%, at least 75%, at least 80%, at least 85%, at least 90%, at least 91%, at least 92%, at least 93%, at least 94%, at least 95%, at least 96%, at least 97%, or even more preferably at least 98% but less than 100% identical to amino acids 1-296 of SEQ ID NO: 11. Preferably, the mannanase variant comprises the amino acid substitutions E234Q and/or N282Y according to the numbering of SEQ ID NO: 11 and an amino acid sequence which is at least 65%, preferably at least 70%, at least 75%, at least 80%, at least 85%, at least 90%, at least 91%, at least 92%, at least 93%, at least 94%, at least 95%, at least 96%, at least 97%, or even more preferably at least 98% but less than 100% identical to amino acids 1-296 of SEQ ID NO: 11.

In another embodiment, the mannanase is a variant comprising or consisting of amino acids 1-296 of SEQ ID NO: 11 with the amino acid substitutions Q59V, N66D, A89H, E234Q, W259M, and N282Y, according to the numbering of SEQ ID NO: 11, and optionally additionally comprises one or more, preferably 1-10, more preferably 1-5 conservative amino acid substitutions.

In another embodiment, the mannanase is a variant consisting of amino acids 1-296 of SEQ ID NO: 11 with the amino acid substitutions Q59V, N66D, A89H, E234Q, W259M, N282Y, according to the numbering of SEQ ID NO: 11, and optionally additionally comprises one or more, preferably 1-10, more preferably 1-5 conservative amino acid substitutions.

Preferably, the mannanase is a variant of a parent mannanase that comprises at least one, at least two, at least three, at least four, at least five, at least six, at least seven, at least eight or all amino acid substitutions selected from the group consisting of X59V, X66D, X89H, X234Q, X259M, X282Y, X318N, X319G, and X322G according to the numbering of SEQ ID NO: 11 and an amino acid sequence which is at least 90%, preferably at least 95%, at least 96%, at least 97%, or even more preferably at least 98% but less than 100% identical to SEQ ID NO: 11.

More preferably, the mannanase is a variant comprising or consisting of SEQ ID NO: 11 with the amino acid substitutions Q59V, N66D, A89H, E234Q, W259M, N282Y, T318N, E319G, and S322G according to the numbering of SEQ ID NO: 11.

Particularly preferred, the mannanase variant has at least 80%, at least 85%, at least 90%, at least 95%, at least 96%, at least 97%, at least 98%, at least 99%, or 100% sequence identity to SEQ ID NO: 12 and comprises the amino acid substitutions Q59V, N66D, A89H, E234Q, W259M, N282Y, T318N, E319G, and S322G according to the numbering of SEQ ID NO: 11.

Particularly preferred, the mannanase variant comprises the amino acid substitutions Q59V, N66D, A89H, E234Q, W259M, N282Y, T318N, E319G, and S322G according to the numbering of SEQ ID NO: 11 and differs from SEQ ID NO: 12 only by 1-20, preferably 1-10, more preferably 1-5, amino acid substitutions, preferably conservative amino acid substitutions.

Most preferably, the mannanase variant has 100% sequence identity to SEQ ID NO: 12.

Preferably, the total amount of mannanase in the cleaning composition is 0.000025-0.002 weight %, preferably 0.00025-0.0008 weight %.

### Surfactant Composition

The cleaning composition described herein comprises a surfactant composition as described herein. The surfactant composition of the cleaning composition comprises one or more surfactants, which may be anionic, cationic, non-ionic, semi-polar, zwitterionic, or a mixture thereof. Suitable surfactants are described in more detail in [0008] to [0013] of Reference RF1, excluding soaps, and in [3008] to [3024] and [3026] to [3034] of Reference RF2. The surfactant composition of the cleaning composition is characterized in that the weight ratio of the total amount of all non-ionic surfactants (NIO) in the cleaning composition to the total amount of all surfactants in the cleaning composition is equal or below 0.88 times the weight ratio of the total amount of all alkyl benzene sulfonates (AS) to the total amount of all surfactants in the cleaning composition minus 0.1 (i.e., [NIO]<=0.88*[AS]-0.1, with [X] being the weight ratio of the total amount of X to the total amount of all surfactants in the cleaning composition).

### Non-Ionic Surfactants (NIO)

In one embodiment, the cleaning composition comprises one or more non-ionic surfactants (NIO). Suitable non-ionic surfactants are described in more detail in [00010] of Reference RF1 and in [3009] to [3020] of Reference RF2. Non-limiting examples of non-ionic surfactants include alcohol ethoxylates (AE or AEO), alcohol propoxylates, propoxylated fatty alcohols (PFA), alkoxylated fatty acid alkyl esters, such as ethoxylated and/or propoxylated fatty acid alkyl esters, alkyl phenol ethoxylates (APE), nonyl phenol ethoxylates (NPE), alkyl polyglycosides (APG), alkoxylated amines, fatty acid monoethanolamides (FAM), fatty acid diethanol amides (FADA), ethoxylated fatty acid monoethanolamides (EFAM), propoxylated fatty acid monoethanolamides (PFAM), polyhydroxy alkyl fatty acid am-ides, or N-acyl N-alkyl derivatives of glucosamine (glucamides, GA, or fatty acid glucamide, FA-GA), as well as products available under the trade names SPAN and TWEEN, and combinations thereof.

In one embodiment, the surfactant composition comprises one or more compound of the formula (NIS1a), (NIS1b), or (NIS1c):

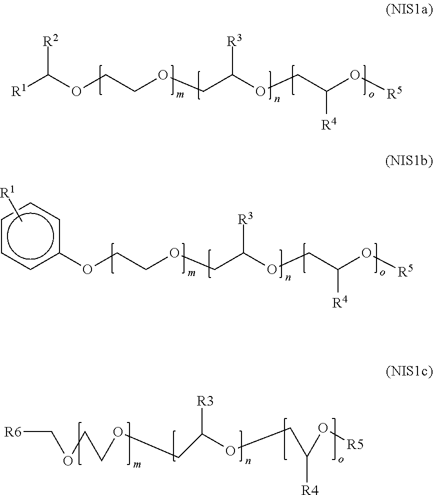

The variables of the formula (NIS1a), (NIS1b) and (NIS1c) are defined as follows:
R1 is selected from H, C1-C23 alkyl and C2-C23 alkenyl, wherein alkyl and/or alkenyl are linear (straight-chain; n-) or branched; examples are n-C7H15, n-C8H17, n-C9H19, n-C11H23, n-C13H27, n-C15H31, n-C17H35, i-C9H19, i-C12H25.
R2 is selected from H, C1-C20 alkyl and C2-C20 alkenyl, wherein alkyl and/or alkenyl are linear (straight-chain; n-) or branched.
R3 and R4, each independently selected from H, C1-C16 alkyl, wherein alkyl is linear (straightchain; n-) or branched; examples are methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl, isodecyl.
R5 is selected from H and C1-C18 alkyl, wherein alkyl is linear (straight-chain; n-) or branched.
R6 is selected from (wherein the dotted line indicates binding to NIS1c):

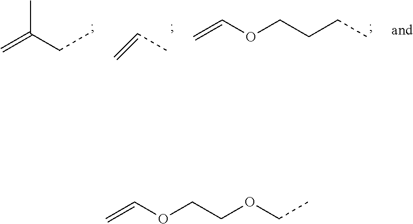

The integers of the formula (NIS1a), (NIS1b) and (NIS1c) are defined as follows:
m is in the range of zero to 200, preferably 1-80, more preferably 3-20; n and o, each independently in the range of zero to 100; n preferably is in the range of 1 to 10, more preferably 1 to 6; o preferably is in the range of 1 to 50, more preferably 4 to 25. The sum of m, n and o is at least one, preferably the sum of m, n and o is in the range of 5 to 100, more preferably in the range of from 9 to 50.

Surfactants according to formula NIS1a, NIS1b, and NIS1c are also called alcohol ethoxylates (AEO).

Preferably, the surfactant composition comprises one or more alcohol ethoxylates. Preferably, the surfactant composition comprises one or more ethoxylated C10-C18 alcohol, preferably oxoalcohol, preferably C13-C15-oxoalcohol, preferably with 6-8 EO. Preferably, the surfactant composition comprises one or more non-ionic surfactant according to the formula (NIS1a). Preferably, the surfactant composition comprises one or more alcohol ethoxylate, preferably, one or more ethoxylated C10-C18 alcohol, preferably oxoalcohol, according to the formula (NIS1a), preferably one or more ethoxylated C13-C15-oxoalcohol, preferably with 6-8 EO, according to the formula (NIS1a). Preferably, the surfactant composition comprises one or more AEO of formula (NIS1a), wherein R1 is C9-C17 alkyl, preferably saturated alkyl, preferably C11-C13 alkyl, R2 is H, R5 is H, m=6-8, n and o being 0.

### Anionic Surfactants

In one embodiment, the surfactant composition of the cleaning composition comprises one or more anionic surfactants as described herein, wherein soaps as defined herein, are not understood as anionic surfactants. Suitable anionic surfactants are described in more detail in [0009] of Reference RF1, excluding soaps, and in [3021] to [3024] and [3026] to [3029] of Reference RF2. Non-limiting examples of anionic surfactants include sulfates and sulfonates, in particular linear alkyl benzene sulfonates (LAS), isomers of LAS, branched alkyl benzene sulfonates (BAS or BABS), phenyl alkane sulfonates, alpha-olefin sulfonates (AOS), olefin sulfonates, alkene sulfonates, alkane-2,3-diylbis(sulfates), hydroxy alkane sulfonates and disulfonates, alkyl sulfates such as sodium dodecyl sulfate (SDS), fatty alcohol sulfates (FAS), primary alcohol sulfates (PAS), alcohol ether sulfates (AES or AEOS or FES, also known as alcohol ethoxy sulfates or fatty alcohol ether sulfates), secondary alkane sulfonates (SAS), paraffin sulfonates (PS), ester sulfonates, sulfonated fatty acid glycerol esters, alpha-sulfo fatty acid methyl esters (alpha-SFMe or SES) including methyl ester sulfonate (MES), alkyl- or alkenyl succinic acid, dodecenyl/tetradecenyl succinic acid (DTSA), fatty acid derivatives of amino acids, or diesters and monoesters of sulfo succinic acid, and combinations thereof.

### Alkyl Benzene Sulfonates (AS)

In one embodiment, the surfactant composition comprises one or more alkyl benzene sulfonates (AS) as described herein. Preferably, the surfactant composition comprises one or more alkyl benzene sulfonates (AS) as described herein. Preferably, the alkyl benzene sulfonate is a C9-C20 alkyl benzene sulfonate, more preferably a C10-C15 alkyl benzene sulfonate, most preferably a C10-C13 alkyl benzene sulfonate. In one embodiment, the alkyl benzene sulfonate is selected from compounds of the formula (AS2a)

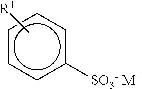

wherein R1 in formula (AS2a) is linear or branched, or a mixture of linear and branched C10-C20, preferably C10-C13 alkyl; M+ being preferably Na+ or Ca2+.

In one embodiment, the one or more anionic surfactant is a linear alkyl benzene sulfonate (LAS), i.e., with R1 in formula (AS2a) being linear alkyl. In another embodiment, the one or more anionic surfactant is a branched alkyl benzene sulfonate (BAS), i.e., with R1 in formula (AS2a) being branched alkyl. In one embodiment, the alkyl benzene sulfonate is a mixture of LAS and BAS. Preferably, the alkyl benzene sulfonate is a C9-C20 alkyl benzene sulfonate, more preferably a C10-C15 alkyl benzene sulfonate, most preferably a C10-C13 alkyl benzene sulfonate. Preferably, the alkyl benzene sulfonate is a linear alkyl benzene sulfonate with C9-C20 alkyl, more preferably C10-C15 alkyl, most preferably C10-C13 alkyl. Preferably, the surfactant composition comprises one or more alkyl benzene sulfonate according to the formula (AS2a). Preferably, the surfactant composition comprises one or more alkyl benzene sulfonate according to the formula (AS2a) with R1 being linear and/or branched, preferably linear, C9-C20 alkyl, more preferably C10-C15 alkyl, most preferably C10-C13 alkyl and M+ being preferably Na+ or Ca2+.

### Sulfates and Carboxylates

In one embodiment, the surfactant composition comprises one or more compounds of the formula (AS1a) or (AS1b):

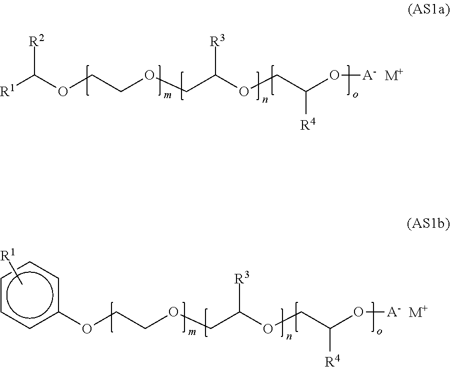

The variables in formula (AS1a and AS1b) are defined as follows:
R1 is selected from C1-C23-alkyl (such as 1-, 2-, 3-, 4-C1-C23-alkyl) and C2-C23-alkenyl, wherein alkyl and/or alkenyl are linear (straight-chain; n-) or branched, and wherein 2-, 3-, or 4-alkyl; examples are n-C7H15, n-C9H19, n-C11H23, n-C13H27, n-C15H31, n-C17H35, i-C9H19, i-C12H25.
R2 is selected from H, C1-C20-alkyl and C2-C20-alkenyl, wherein alkyl and/or alkenyl are linear (straight-chain; n-) or branched.
R3 and R4, each independently selected from C1-C16-alkyl, wherein alkyl is linear (straightchain; n-) or branched; examples are methyl, ethyl, n-propyl, isopropyl, n-butyl, isobutyl, secbutyl, tert-butyl, n-pentyl, isopentyl, sec-pentyl, neopentyl, 1,2-dimethylpropyl, isoamyl, nhexyl, isohexyl, sec-hexyl, n-heptyl, n-octyl, 2-ethylhexyl, n-nonyl, n-decyl, isodecyl.
A- is selected from —RCOO—, —SO3- and —RSO3-, wherein R is selected from linear (straightchain; n-) or branched C1-C8-alkyl and C1-C4 hydroxyalkyl. Compounds are called (fatty) alcohol/alkyl (ethoxy/ether) sulfates [(F)A(E)S] when A- is —SO3- or —RSO3- and (fatty) alcohol/alkyl (ethoxy/ether) carboxylate [(F)A(E)C] when A- is —RCOO—.

Compounds of formula AS1a or AS1b, which are alkyl ether sulfates with A- being —SO3- are also called AES. M+ is selected from H and salt forming cations. Salt forming cations may be monovalent or multivalent; hence M+ equals 1/v Mv+. Examples include but are not limited to sodium, potassium, magnesium, calcium, ammonium, and the ammonium salt of mono-, di, and triethanolamine.

The integers of the formula (AS1a) and (AS1b) are defined as follows:
m is in the range of zero to 200, preferably 1-80, more preferably 3-20; n and o, each independently in the range of zero to 100; n preferably is in the range of 1 to 10, more preferably 1 to 6; o preferably is in the range of 1 to 50, more preferably 4 to 25. The sum of m, n and o is in the range of 0 to 100. In one embodiment, the sum of m, n and o is 0. In another embodiment the sum of m, n and o is at least one, preferably the sum of m, n and o is in the range of 9 to 50.

Anionic surfactants of the formula (AS1a) and (AS1b) may be of any structure, block copolymers or random copolymers.

Preferably, the surfactant composition comprises one or more alkyl ether sulfates (AES). Preferably, the surfactant composition comprises one or more C12-C15 alcohol ether sulfate, linear or branched, preferably with 1-3 EO.

Preferably, the surfactant composition comprises one or more compounds of formula (AS1a). Preferably, the surfactant composition comprises one or more alkyl ether sulfates of formula (AS1a). Preferably, the surfactant composition comprises one or more C12-C15 alcohol ether sulfate, linear or branched, preferably with 1-3 EO, according to the formula (AS1a). Preferably, the surfactant composition comprises one or more C12-C14 fatty alcohol ether sulfate, preferably with 1-3 EO, according to the formula (AS1a).

Preferably, the surfactant composition comprises one or more AES of formula (AS1a), wherein R1 is C9-C15 alkyl, preferably saturated alkyl, preferably C11-C13 alkyl, R2 is H, A- is —SO3-, m=1-3, n and o being 0 and M+ is preferably Na+.

### Other Surfactants

The surfactant composition may comprise one or more cationic, semipolar, zwitterionic, or amphoteric surfactant. Preferably, the surfactant composition may comprise one or more amphoteric surfactant. Suitable amphoteric surfactants are described in more detail in [00011] of Reference RF1 and in [3030] to [3034] of Reference RF2. Suitable zwitterionic surfactants are described in more detail in [00012] of Reference RF1. Suitable cationic surfactants are described in more detail in [00013] of Reference RF1. Non-limiting examples of semipolar surfactants include amine oxides (AO) such as alkyl dimethyl amine oxide, N-(coco alkyl)-N,N-dimethyl amine oxide and N-(tallow-alkyl)-N,N-bis-(2-hydroxy ethyl) amine oxide, fatty acid alkanol amides and ethoxylated fatty acid alkanol amides, and combinations thereof. Non-limiting examples of zwitterionic surfactants include betaine, alkyl dimethyl betaine, sulfo betaine, and combinations thereof.

### Builder Composition

The cleaning composition described herein may comprise a builder composition comprising one or more builder. The builder can be a weak builder or a strong builder or a mixture thereof. It is understood herein that the weak and the strong builder can each be composed of one type of builder or can be a mixture of several different type of builders. Preferably, the builder composition of the cleaning composition comprises one or more weak builder and one or more strong builder. Preferably, the ratio between the total amount of all weak builders and the total amount of all strong builders in the cleaning composition is in the range 1.0:0.001 to 1.0:0.5, preferably 1.0:0.005 to 1.0:0.2.

Preferably, the total amount of all builders in the cleaning composition is 0.1-9 weight %, preferably 0.1-7 weight %, 1-7 weight %, 1-6 weight %, 2-6 weight %, 2-4 weight %, or preferably 2.5-3.5 weight %.

Preferably, the total amount of weak builder in the cleaning composition is 0.1-9 weight %, preferably 0.1-7 weight %, 1-6 weight %, 2-6 weight %, 2-4 weight %, or preferably 2.5-3.5 weight %.

Preferably, the total amount of strong builder in the cleaning composition is 0.0001-4.5 weight %, preferably 0.001-0.3 weight %.

Suitable builders are described in more detail in paragraphs to of Reference RF1 and in paragraphs to of Reference RF2.

### Weak Builder

Preferably, the weak builder is selected from the group consisting of citric acid, amino-tris-methylene-phosphonic acid (AMP), succinate, acetate, and salts thereof. Preferably, the weak builder is a weak sequestering builder. Preferably, the weak builder is citrate. Citrates include the mono- and the dialkali metal salts and in particular the mono- and preferably the trisodium salt of citric acid, ammonium or substituted ammonium salts of citric acid as well as citric acid as such. Citrate can be used as the anhydrous compound or as the hydrate, for example as sodium citrate dihydrate. Most preferred is sodium citrate.

### Strong Builder

Preferably, the strong builder is selected from the group consisting of phosphates, silicates, carbonates, phosphonates, amino carboxylates and polycarboxylates. Preferably, the strong builder is a strong sequestering builder. Preferably the strong builder is selected from the group consisting of methylglycinediaceticacid (MGDA), ethylenediaminedisuccinic acid (EDDS), diaminetetramethylenephosphonate (EDTMP) diethylenetriaminepentamethylenephosphonate (DTPMP), glutamic acid diacetate (GLDA), 1-hydroxyethane-1,1-diphosphonate (HEDP), ethylenediaminetetraacetic acid (EDTA), nitrilotrimethylenephosphonic acid (NTMP), nitrilotriacetic acid (NTA), pyrophosphate, sodium tripolyphosphate (STPP), iminodisuccinic acid (IDS), and salts thereof. Preferably, the strong builder is selected from the group consisting of MGDA, EDDS, DTPMP and salts thereof.

Preferably, the one or more strong builder is a phosphonate, preferably DTPMP.

Preferably the builder composition comprises a builder selected from the group consisting of citric acid, amino-tris-methylene-phosphonic acid (AMP), succinate, acetate, and salts thereof, preferably citrate.

Preferably the builder composition comprises a builder selected from the group consisting of methylglycinediaceticacid (MGDA), ethylenediaminedisuccinic acid (EDDS), diaminetetramethylenephosphonate (EDTMP) diethylenetriaminepentamethylenephosphonate (DTPMP), glutamic acid diacetate (GLDA), 1-hydroxyethane-1,1-diphosphonate (HEDP), ethylenediaminetetraacetic acid (EDTA), nitrilotrimethylenephosphonic acid (NTMP), nitrilotriacetic acid (NTA), pyrophosphate, sodium tripolyphosphate (STPP), iminodisuccinic acid (IDS), and salts thereof, preferably selected from the group consisting of MGDA, EDDS, DTPMP and salts thereof. Preferably, the builder composition of the cleaning composition comprises a phosphonate, preferably DTPMP.

Preferably the builder composition comprises a builder selected from the group consisting of citric acid, amino-tris-methylene-phosphonic acid (AMP), succinate, acetate, and salts thereof, and preferably comprises a builder selected from the group consisting of methylglycinediaceticacid (MGDA), ethylenediaminedisuccinic acid (EDDS), diaminetetramethylenephosphonate (EDTMP) diethylenetriaminepentamethylenephosphonate (DTPMP), glutamic acid diacetate (GLDA), 1-hydroxyethane-1,1-diphosphonate (HEDP), ethylenediaminetetraacetic acid (EDTA), nitrilotrimethylenephosphonic acid (NTMP), nitrilotriacetic acid (NTA), pyrophosphate, sodium tripolyphosphate (STPP), iminodisuccinic acid (IDS), and salts thereof.

Preferably, the builder composition of the cleaning composition comprises citrate and one or more compound selected from the group consisting of MGDA, EDDS, DTPMP and salts thereof. Preferably, the builder composition of the cleaning composition comprises citrate and a phosphonate, preferably DTPMP.

### Further Components

The cleaning compositions described herein including the compounds described herein may—and preferably does—contain further adjunct cleaning additives (also abbreviated herein as “adjuncts”). Suitable additional adjunct cleaning additives are further described in Reference RF1 and Reference RF2.

Preferably, the cleaning composition comprises one or more additional adjunct cleaning additive selected from the group consisting of polymers, further enzymes, enzyme stabilizing systems, soaps, structurants or thickeners, clay soil removal/anti-redeposition agents, solubilizing agents, bleaching compounds, bleaching agents, bleach activators, bleach catalysts, brighteners, malodor control agents, pigments, dyes, opacifiers, hueing agents, dye transfer inhibiting agents, chelating agents, suds boosters, suds suppressors (antifoams), color speckles, silver care, anti-tarnish and/or anti-corrosion agents, alkalinity sources, pH adjusters, pH-buffer agents, hydrotropes, scrubbing particles, antibacterial agents, anti-oxidants, softeners, carriers, processing aids, pro-perfumes, dye fixation agent, and perfumes.

### Soaps

In one embodiment, the cleaning composition comprises one or more soaps (AS4). In one embodiment, AS4 are selected from salts (M+) of saturated and unsaturated C12-C18 fatty acids (AS4a), such as lauric acid, myristic acid, palmitic acid, stearic acid, behenic acid, oleic acid, (hydrated) erucic acid. M+ is selected from salt forming cations. Salt forming cations may be monovalent or multivalent; hence M+ equals 1/v Mv+.

Examples include but are not limited to sodium, potassium, magnesium, calcium, ammonium, and the ammonium salt of mono-, di-, and tri-ethanolamine.

In one embodiment, AS4 are salts (M+) derived from natural fatty acids (AS4b) such as tallow (mainly C14-C18), coconut oil (mainly C12-C18), palm kernel oil (mainly C8-C18), olive oil (mainly C16-C18) or canola oil (mainly C18). Preferably, the surfactant composition comprises one or more salt of a coco-fatty acid, preferably one or more salt of a coco-fatty acid with C12-C18.

### Additional Enzymes

In preferred embodiments, the cleaning compositions comprise one or more additional enzyme different to the mannanase described herein. The composition described herein can comprise more than one enzyme of different types, e.g., a mannanase and a protease, or more than one enzyme of the same type, e.g., two or more different mannanases, or mixtures thereof, e.g., a protease and two different mannanases of which one is the mannanase variant described herein. “Additional enzymes” are defined in more detail in paragraphs [0020] to [0027] of Reference RF1.

These additional enzymes may include hydrolases, such as additional mannanase, protease, amylases, lipases, DNases, cellulases, hemicellulases, phospholipases, esterases, xylanases, dispersins, oxidoreductases, cutinases, pectate lyases, pectinases, lactases and peroxidases. Preferably, the additional enzyme is selected from the group consisting of protease, amylases, lipases, mannanases other than the mannanase variant described herein, cellulases, and combinations of at least two of the foregoing types. Most preferably, the one or more additional enzyme is a protease and/or an amylase, preferably, a protease and an amylase.

### Protease Variant

The cleaning composition described herein may comprises one or more protease variant as described herein. Protease variants according to the invention have “proteolytic activity” (also referred to as “protease activity”). This property is related to hydrolytic activity of a protease (i.e., proteolysis, which means hydrolysis of peptide bonds linking amino acids together in a polypeptide chain) on protein containing substrates, e.g., casein, haemoglobin, and BSA. Quantitatively, proteolytic activity is related to the rate of degradation of protein by a protease or proteolytic enzyme in a defined course of time. The methods for analyzing proteolytic activity are well-known in the literature (see e.g. Gupta et al. (2002), Appl. Microbiol. Biotechnol. 60:381-395). For instance, proteolytic activity can be determined by using Succinyl-Ala-Ala-Pro-Phe-p-nitroanilide (Suc-AAPF-pNA, short AAPF; see e.g. DelMar et al. (1979), Analytical Biochem 99, 316-320) as substrate. pNA is cleaved from the substrate molecule by proteolytic cleavage, resulting in release of yellow color of free pNA which can be quantified by measuring OD405.

To determine changes in proteolytic activity over time, the “initial enzymatic activity” of a protease is measured under defined conditions at time zero and at a certain point in time later. By dividing the latter activity with the activity at time point zero the residual activity can be calculated (x %). By comparison of the 100%-value with the x %-value, a potential loss of proteolytic activity can be determined in its extent.

Suitable proteases are described in more detail in paragraphs of Reference RF1.

Preferably, the protease variant comprises as a catalytic triad the amino acids aspartate, histidine, and serine, preferably the protease variant is a subitilisin protease. Preferably, the protease variant is preferably a protease variant of the parent protease shown in SEQ ID NO: 1. Preferably, the protease variant comprises an amino acid sequence which is at least 60%, preferably at least 80%, but less than 100% identical to SEQ ID NO: 1 and wherein the amino acid sequence of the protease variant comprises compared to SEQ ID NO: 1 at least one, preferably at least two, additional negative charges in the loop region of residues 98 to 104 according to the numbering of SEQ ID NO: 2 (BPN′ numbering, i.e., wherein the positions are numbered by their correspondence to the amino acid sequence of subtilisin BPN′ of B. amyloliquefaciens, established as SEQ ID NO: 2).

Preferably, the at least one, preferably at least two, additional negative charges in the loop region of residues 98 to 104 according to the numbering of SEQ ID NO: 2 are obtained by one or more amino acid alterations selected from the group consisting of substitutions, deletions and insertions, preferably by substitutions.

Preferably, in the protease variant the at least one, preferably at least two, additional negative charges compared to SEQ ID NO: 1 in the loop region of residues 98 to 104 are caused by one or more amino acid substitutions at amino acid position selected from the group consisting of 98, 99, 100, 101, 102, 103, and 104, preferably at position 101, according to the numbering of SEQ ID NO: 2.

Preferably, the at least one, preferably at least two, additional negative charges in the loop region of residues 98 to 104 according to the numbering of SEQ ID NO: 2 are obtained by one or more amino acid alterations selected from the group consisting of D99E, R101D and R101E. In a preferred embodiment, the protease variant comprises an amino acid sequence which comprises compared to SEQ ID NO: 1 the amino acid substitution R101E or R101D, preferably R101E, according to the numbering of SEQ ID NO: 2.

Preferably, the protease variant has at least 60%, at least 65%, at least 70%, at least 75%, at least 80%, at least 85%, at least 90%, at least 95%, at least 96%, at least 97%, at least 98%, or at least 99%, but less than 100% sequence identity to SEQ ID NO: 1 and comprises compared to SEQ ID NO: 1 the amino acid substitution R101D or R101E, preferably R101E, according to the numbering of SEQ ID NO: 2.

In one embodiment, the protease variant has at least 80% sequence identity to SEQ ID NO: 1 and comprises compared to SEQ ID NO: 1 at least one, preferably at least two, additional negative charges in the loop region of residues 98 to 104 according to the numbering of SEQ ID NO: 2, wherein compared to SEQ ID NO: 1 the protease variant comprises one or more conservative amino acid exchanges as described herein. Preferably, compared to SEQ ID NO: 1 the protease variant comprises at least 1, at least 2, at least 3, at least 4, at least 5, at least 6, at least 10, at least 15, at least 20, at least 30 or at least 40 conservative amino acid exchanges. Thus, compared to SEQ ID NO: 1 a protease variant described herein can comprise 1, 2, 3, 4, 5, 6, 7, 8, 9, or 10 conservative amino acid exchanges in addition to the modifications resulting in at least one, preferably at least two, additional negative charges in the loop region of residues 98 to 104, preferably in addition to the substitution R101D or R101E, preferably R101E according to the numbering of SEQ ID NO: 2. Preferably, the protease variant has at least 80%, at least 85%, at least 90%, at least 95%, at least 96%, at least 97%, at least 98%, or at least 99%, but less than 100% sequence identity to SEQ ID NO: 1 and comprises compared to SEQ ID NO: 1 at least one, preferably at least two, additional negative charges in the loop region of residues 98 to 104 according to the numbering of SEQ ID NO: 2, wherein compared to SEQ ID NO: 1 the remaining difference in amino acid sequence is due to conservative amino acid exchanges as described herein.

More preferably, the protease variant has at least 80%, at least 85%, at least 90%, at least 95%, at least 96%, at least 97%, at least 98%, at least 99%, but less than 100% sequence identity to SEQ ID NO: 1 and comprises the amino acid substitution R101E according to the numbering of SEQ ID NO: 2.

Particularly preferred, the protease variant has at least 80%, at least 85%, at least 90%, at least 95%, at least 96%, at least 97%, at least 98%, at least 99%, or 100% sequence identity to SEQ ID NO: 3 and comprises the amino acid substitution R101E according to the numbering of SEQ ID NO: 2.

Particularly preferred, the protease variant comprises a glutamic acid (E) at position 101 according to the numbering of SEQ ID NO: 2 and differs from SEQ ID NO: 3 only by 1-20, preferably 1-10, more preferably 1-5, amino acid substitutions, preferably conservative amino acid substitutions.

Most preferably, the protease variant has 100% sequence identity to SEQ ID NO: 3.

Preferably, the total amount of protease in the cleaning composition is 0-0.075 weight %, 0.005-0.075 weight %, or preferably 0.01-0.06 weight %.

### Amylase Variant

The cleaning composition described herein may comprises one or more amylase variants as described herein. “Amylases” can include those of bacterial or fungal origin (EC 3.2.1.1 and 3.2.1.2, respectively). Preferably, amylases are selected from the group of alpha-amylases (EC 3.2.1.1).

Amylases described herein have “amylolytic activity” or “amylase activity” involving (endo) hydrolysis of glucosidic linkages in polysaccharides. alpha-amylase activity may be determined by assays for measurement of alpha-amylase activity which are known to those skilled in the art. For example, alpha-amylase activity can be determined by a method employing Phadebas tablets as substrate (Phadebas Amylase Test, supplied by Magle Life Science). Starch is hydrolyzed by the alpha-amylase giving soluble blue fragments. The absorbance of the resulting blue solution, measured spectrophotometrically at 620 nm, is a function of the alpha-amylase activity. The measured absorbance is directly proportional to the specific activity (activity/mg of pure alpha-amylase protein) of the alpha-amylase in question under the given set of conditions.

Alpha-amylase activity can also be determined by a method employing the Ethyliden-4-nitrophenyl-alpha-D-maltoheptaosid (EPS). D-maltoheptaoside is a blocked oligosaccharide which can be cleaved by an endo-amylase. Following the cleavage, the alpha-glucosidase included in the kit to digest the substrate to liberate a free PNP molecule which has a yellow color and thus can be measured by visible spectophotometry at 405 nm. Kits containing EPS substrate and alpha-glucosidase is manufactured by Roche Costum Biotech (cat. No. 10880078103). The slope of the time dependent absorption-curve is directly proportional to the specific activity (activity per mg enzyme) of the alpha-amylase in question under the given set of conditions.

Amylolytic activity may be provided in units per gram enzyme. For example, 1 unit alpha-amylase may liberate 1 mg of maltose from starch in 3 min at pH 6.9 at 20° C.

Suitable amylases are described in more detail in paragraphs of Reference RF1.

In one embodiment, the amylase variant
(i) comprises an amino acid substitution at position 25 according to the numbering of SEQ ID NO: 15,
(ii) comprises an amino acid substitution at one or more, preferably two or more, amino acid positions corresponding to amino acid positions selected from the group consisting of 116, 176, 181, 186, 195, 206, 225, 320, and 482 according to the numbering of SEQ ID NO: 15, and
(iii) has at least 60%, but less than 100% sequence identity with SEQ ID NO: 14 or SEQ ID NO: 15, preferably SEQ ID NO: 14.

Preferably, said amylase variant comprises an amino acid substitution at one or more positions selected from the group consisting of 116, 181, 225, and 320 (according to the numbering of SEQ ID NO: 15).

Preferably, said amylase variant comprises an amino acid substitution at one or more positions selected from the group consisting of 195 or 206, preferably said amylase variant comprises an amino acid substitution at either position 195 or position 206 (according to the numbering of SEQ ID NO: 15).

Preferably, said amylase variant comprises an amino acid substitution at position 482 (according to the numbering of SEQ ID NO: 15).

Preferably, said amino acid substitution at position 25 is X25H (according to the numbering of SEQ ID NO: 15).

Preferably, said amino acid substitution at position 116 is X116K, wherein said amino acid substitution at position 176 is X176K, wherein said amino acid substitution at position 181 is X181T, wherein said amino acid substitution at position 186 is X186E, wherein said amino acid substitution at position 195 is X195F, wherein said amino acid substitution at position 206 is X206Y, wherein said amino acid substitution at position 225 is X225A, wherein said amino acid substitution at position 320 is X320K, and wherein said amino acid substitution at position 482 is X482W (according to the numbering of SEQ ID NO: 15).

Preferably, said amylase variant comprises (according to the numbering of SEQ ID NO: 15)
a) a substitution at amino acid position 195, preferably X195F, or a substitution at amino ac-id position 206, preferably X206Y, and a substitution at one or more positions selected from 176 and 186; preferably one or more substitutions selected from X176K and X186E, or
b) a substitution at amino acid position 195, preferably X195F, or a substitution at amino ac-id position 206, preferably X206Y, and a substitution at one or more positions selected from 116, 181, 225, and 320, preferably one or more substitutions selected from X116K, X225A, and X320K, or
c) a substitution at amino acid position 195, preferably X195F, or a substitution at amino ac-id position 206, preferably X206Y, and a substitution at one or more positions selected from 176 and 186, preferably one or more substitutions selected from X176K and X186E, and a substitution at one or more positions selected from 116, 181, 225, and 320, prefer-ably one or more substitutions selected from X116K, X225A, and X320K.

Particularly preferred, the amylase variant comprises
(i) a combination of amino acid substitutions selected from the group consisting of (according to the numbering of SEQ ID NO: 15):

$$X 25 H + X 116 K + X 181 T + X 206 Y + X 225 A + X 320 K , X 25 H + X 116 K + X 176 K + X 181 T + X 206 Y + X 225 A + X 320 K , X 25 H + X 116 K + X 181 T + X 186 E + X 206 Y + X 225 A + X 320 K , X 25 H + X 116 K + X 181 T + X 206 Y + X 225 A + X 320 K + X 482 W , X 25 H + X 116 K + X 176 K + X 181 T + X 186 E + X 206 Y + X 225 A + X 320 K , X 25 H + X 116 K + X 176 K + X 181 T + X 206 Y + X 225 A + X 320 K + X 482 W , X 25 H + X 116 K + X 181 T + X 186 E + X 206 Y + X 225 A + X 320 K + X 482 W , X 25 H + X 116 K + X 176 K + X 181 T + X 186 E + X 206 Y + X 225 A + X 320 K + X 482 W , X 25 H + X 116 K + X 181 T + X 195 F + X 225 A + X 320 K , X 25 H + X 116 K + X 176 K + X 181 T + X 195 F + X 225 A + X 320 K , X 25 H + X 116 K + X 181 T + X 186 E + X 195 F + X 225 A + X 320 K , X 25 H + X 116 K + X 181 T + X 195 F + X 225 A + X 320 K + X 482 W , X 25 H + X 116 K + X 176 K + X 181 T + X 186 E + X 195 F + X 225 A + X 320 K , X 25 H + X 116 K + X 176 K + X 181 T + X 195 F + X 225 A + X 320 K + X 482 W , X 25 H + X 116 K + X 181 T + X 186 E + X 195 F + X 225 A + X 320 K + X 482 W , and \\ X 25 H + X 116 K + X 176 K + X 181 T + X 186 E + X 195 F + X 225 A + X 320 K + X 482 W ,$$

(ii) at least 85%, at least 85.5%, at least 86%, at least 86.5%, at least 87%, at least 87.5%, at least 88%, at least 88.5%, at least 89%, at least 89.5%, at least 90%, at least 90.5%, at least 91%, at least 91.5%, at least 92%, at least 92.5%, at least 93%, at least 93.5%, at least 94%, at least 94.5%, at least 95%, at least 95.5%, at least 96%, at least 96.5%, at least 97%, at least 97.5%, at least 98%, at least 98.5%, at least 99%, or at least 99.5%, but less than 100% sequence identity with SEQ ID NO: 14, and
(iii) a deletion of two amino acids corresponding to positions selected from the group consisting of 181, 182, 183 and 184, preferably a deletion of amino acids corresponding to positions 181 and 182, 182 and 183, or 183 and 184, preferably the deletion D183* and G184* (according to the numbering of SEQ ID NO: 15).

Especially preferred is an amylase variant comprising
(i) the combination of amino acid substitutions (according to the numbering of SEQ ID NO: 15):

$$X 25 H + X 116 K + X 176 K + X 181 T + X 186 E + X 195 F + X 225 A + X 320 K + X 482 W , X 25 H + X 116 K + X 176 K + X 181 T + X 186 E + X 206 Y + X 225 A + X 320 K , or \\ X 25 H + X 116 K + X 176 K + X 181 T + X 186 E + X 206 Y + X 225 A + X 320 K + X 482 W$$

(ii) at least 90%, at least 90.5%, at least 91%, at least 91.5%, at least 92%, at least 92.5%, at least 93%, at least 93.5%, at least 94%, at least 94.5%, at least 95%, at least 95.5%, at least 96%, at least 96.5%, at least 97%, at least 97.5%, at least 98%, at least 98.5%, at least 99%, or at least 99.5%, but less than 100% sequence identity with SEQ ID NO: 14, and
(iii) a deletion of two amino acids corresponding to positions selected from the group consisting of 181, 182, 183 and 184, preferably a deletion of amino acids corresponding to positions 181 and 182, 182 and 183, or 183 and 184, preferably the deletion D183* and G184* (according to the numbering of SEQ ID NO: 15).

Preferred is an amylase variant comprising or consisting of the amino acid sequence set forth in SEQ ID NO: 14 with the amino acid alterations X25H+X116K+X176K+X181T+X186E+X195F+X225A+X320K+X482W, X25H+X116K+X176K+X181T+X186E+X206Y+X225A+X320K+D183*+G184*, or X25H+X116K+X176K+X181T+X186E+X206Y+X225A+X320K+X482W according to the numbering of SEQ ID NO: 15.

Preferred is an amylase variant comprising or consisting of the amino acid sequence set forth in SEQ ID NO: 14 with the amino acid alterations X25H+X116K+X176K+X181T+X186E+X195F+X225A+X320K+X482W according to the numbering of SEQ ID NO: 15.

Thus, preferred is an amylase variant comprising or consisting of the amino acid sequence set forth in SEQ ID NO: 14 with the amino acid alterations N25H+W116K+R176K+R181T+G186E+N195F+T225A+R320K+Y482W according to the numbering of SEQ ID NO: 15.

In another embodiment, the amylase variant
(i) comprises an amino acid substitution at position 4 according to the numbering of SEQ ID NO: 15,
(ii) comprises an amino acid substitution at one or more, preferably two or more, amino acid positions corresponding to amino acid positions selected from the group consisting of 25, 176, 186, 251, 405, and 482 according to the numbering of SEQ ID NO: 15, and
(iii) has at least 60%, but less than 100% sequence identity with SEQ ID NO: 14 or SEQ ID NO: 15, preferably SEQ ID NO: 14.

Preferably, said amino acid substitution at position 4 is X4Q, said amino acid substitution at position 25 is X25H, said amino acid substitution at position 176 is X176K, said amino acid substitution at position 186 is X186E, said amino acid substitution at position 251 is X251E, said amino acid substitution at position 405 is X405M, and said amino acid substitution at position 482 is X482W.

Preferably, said amylase variant comprises
a) a substitution at one or more positions selected from 25, 176, and 186; preferably one or more substitutions selected from X25H, X176K, and X186E, or
b) a substitution at one or more positions selected from 251, 405, and 482, preferably one or more substitutions selected from X251E, X405M, and X482W, or
c) a substitution at one or more positions selected from 25, 176, and 186, preferably one or more substitutions selected from X25H, X176K, and X186E, and a substitution at one or more positions selected from 251, 405, and 482, preferably one or more substitutions selected from X251E, X405M, and X482W.

Particularly preferred, the amylase variant of the present invention comprises
(i) a combination of amino acid substitutions selected from the group consisting of (according to the numbering of SEQ ID NO: 15):

$$X 4 Q + X 25 H + X 176 K + X 186 E , X 4 Q + X 25 H + X 176 K + X 186 E + X 251 E , X 4 Q + X 25 H + X 176 K + X 186 E + X 405 M , X 4 Q + X 25 H + X 176 K + X 186 E + X 482 W , X 4 Q + X 25 H + X 176 K + X 186 E + X 251 E + X 405 M , X 4 Q + X 25 H + X 176 K + X 186 E + X 251 E + X 482 W , X 4 Q + X 25 H + X 176 K + X 186 E + X 405 M + X 482 W , and \\ X 4 Q + X 25 H + X 176 K + X 186 E + X 251 E + X 405 M + X 482 W ,$$

(ii) at least 85%, at least 85.5%, at least 86%, at least 86.5%, at least 87%, at least 87.5%, at least 88%, at least 88.5%, at least 89%, at least 89.5%, at least 90%, at least 90.5%, at least 91%, at least 91.5%, at least 92%, at least 92.5%, at least 93%, at least 93.5%, at least 94%, at least 94.5%, at least 95%, at least 95.5%, at least 96%, at least 96.5%, at least 97%, at least 97.5%, at least 98%, at least 98.5%, at least 99%, or at least 99.5%, but less than 100% sequence identity with SEQ ID NO: 14, and
(iii) a deletion of two amino acids corresponding to positions selected from the group consisting of 181, 182, 183 and 184, preferably a deletion of amino acids corresponding to positions 181 and 182, 182 and 183, or 183 and 184, preferably the deletion D183* and G184* (according to the numbering of SEQ ID NO: 15).

Especially preferred is an amylase variant comprising
(i) the combination of amino acid substitutions (according to the numbering of SEQ ID NO: 15):

$$X 4 Q + X 25 H + X 176 K + X 186 E + X 251 E + X 405 M + X 482 W ,$$

(ii) at least 90%, at least 90.5%, at least 91%, at least 91.5%, at least 92%, at least 92.5%, at least 93%, at least 93.5%, at least 94%, at least 94.5%, at least 95%, at least 95.5%, at least 96%, at least 96.5%, at least 97%, at least 97.5%, at least 98%, at least 98.5%, at least 99%, or at least 99.5%, but less than 100% sequence identity with SEQ ID NO: 14, and
(iii) a deletion of two amino acids corresponding to positions selected from the group consisting of 181, 182, 183 and 184, preferably a deletion of amino acids corresponding to positions 181 and 182, 182 and 183, or 183 and 184, preferably the deletion D183* and G184* (according to the numbering of SEQ ID NO: 15).

In one embodiment, the amylase variant further comprises an amino acid substitution at position 439, preferably X439K, more preferably W439K (according to the numbering of SEQ ID NO: 15), preferably the combination of amino acid substitutions (according to the numbering of SEQ ID NO: 15)

$$X 4 Q + X 25 H + X 176 K + X 186 E + X 251 E + X 405 M + X 439 K + X 482 W .$$

Preferred is thus an amylase variant comprising or consisting of the amino acid sequence set forth in SEQ ID NO: 14 with the amino acid alterations X4Q+X25H+X176K+X186E+X251E+X405M+X439K+X482W according to the numbering of SEQ ID NO: 15. Most preferred is an amylase variant comprising or consisting of the amino acid sequence set forth in SEQ ID NO: 14 with the amino acid alterations X4Q+X25H+X176K+X186E+X251E+X405M+X482W according to the numbering of SEQ ID NO: 15. Thus, most preferred is an amylase variant comprising or consisting of the amino acid sequence set forth in SEQ ID NO: 14 with the amino acid alterations G4Q+N25H+G176K+G186E+T251E+L405M+Y482W according to the numbering of SEQ ID NO: 15.

Preferably, the total amount of amylase in the cleaning composition is 0-0.08 weight %, preferably 0.01-0.06 weight %.

### Enzyme Stabilizing System

In a preferred embodiment, the cleaning composition comprises an enzyme stabilizing system as described herein or in the chapter “Enzyme stabilizing system” of Reference RF1.

Preferably, the enzyme stabilizing system comprises at least one compound selected from the group consisting of polyols (preferably, glycerol, 1,2-propanediol, 1,3-propanediol, ethylene glycol, or sorbitol, preferably 1,2-propanediol), inorganic salts (preferably, CaCl2, MgCl2, or NaCl), short chain (preferably, C1-C3) carboxylic acids or salts thereof (preferably, formic acid, formate (preferably, sodium formate), acetic acid, acetate, or lactate), borate, boric acid, boronic acids (preferably, 4-formyl phenylboronic acid (4-FPBA), peptide aldehydes, peptide acetals, and peptide aldehyde hydrosulfite adducts, preferably peptide aldehydes, preferably the enzyme stabilizing system comprises a protease inhibitor, preferably a peptide aldehyde, more preferably a tripeptide aldehyde, most preferably a tripeptide aldehyde (preferably, Z-VAL-H or Z-GAY-H) and 1,2-propanediol.

Preferably, when a protease variant is present the cleaning composition comprises a protease inhibitor and preferably also 1,2-propanediol.

Preferably, the protease inhibitor is a peptide aldehyde, preferably a tripeptide aldehyde, preferably selected from a compound according to formula (I)

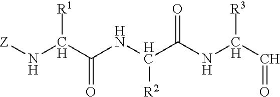

wherein
R1 and R2 are groups such that NH—CHR1-CO and/or NH—CHR2-CO are non-polar amino acids,
R3 is a group such that NH—CHR3-CO is a non-polar amino acid; and
Z is an N-terminal protection group, preferably selected from benzyloxycarbonyl (Cbz), p-methoxybenzyl carbonyl (MOZ), benzyl (Bn), benzoyl (Bz), p-methoxybenzyl (PMB), p-methoxyphenyl (PMP), formyl, acetyl (Ac), methyloxy, alkoxycarbonyl, methoxycarbonyl, fluorenylmethyloxycarbonyl (Fmoc), and tert-butyloxycarbonyl (Boc).

Preferably, R1 and R2 of formula (I) is a group such that NH—CHR1-CO and NH—CHR2-CO is an L- or D-amino acid residue of Gly, Ala, Val, Leu, Ile, Met, Pro, Phe, Trp, Ser, Thr, Asp, Gln, Tyr, Cys, Lys, Arg, His, Asn, Glu, m-tyrosine, 3,4-dihydroxyphenylalanine, Nva, or Nle, preferably independently from each other selected from an L- or D-amino acid residue of Ala, Val, Gly and Leu. Preferably, R3 of formula (I) is a group such that NH—CHR3-CO is an L- or D-amino acid residue of Gly, Ala, Val, Leu, Ile, Met, Pro, Phe, Trp, Ser, Thr, Asp, Gln, Tyr, Cys, Lys, Arg, His, Asn, Glu, m-tyrosine, 3,4-dihydroxyphenylalanine, Nva, or Nle, or wherein R3 is (CH3)3SiCH2, preferably independently from each other selected from an L- or D-amino acid residue of Tyr, Phe, Val, Ala and Leu. Most preferably, the protease inhibitor is Z-VAL-H or Z-GAY-H.

In one embodiment, the cleaning composition comprises a protease inhibitor, preferably a peptide aldehyde, in a molar ratio to the protease of 3:1 to 0.5:1, preferably 2:1 to 1:1.

In preferred embodiments, the cleaning compositions comprise a polymer, preferably cleaning polymers and/or soil release polymers. “Cleaning polymers and soil release polymers” are defined in more detail in paragraphs [0032] to [0034] of Reference RF1. These polymers include polycarboxylates, alkoxylated polyalkylenamines, alkoxylated polyalkylenimines, polyether-based polymers, rheology-modifying polymers, dye inhibition polymers and soil release polymers as defined in more detail in paragraphs [3035] to [3044] of Reference RF2.

Polymers may include, without limitation, “multifunctional alkoxylated polyethylene imines”, “multifunctional alkoxylated diamines” and also terephthalic acid-based polyesters like Clariant's TexCare®, such as TexCare® SRN 170, TexCare® SRN 172, TexCare® SRN 260, TexCare® SRN 260 SG Terra and TexCare® SRA 300 as well as distinct combinations of all of the before mentioned polymers. Also included are graft polymers comprising a polyalkylene oxide based backbone with grafted side chains of vinyl ester monomer and optionally N-vinylpyrrolidone monomers.

In preferred embodiments, the cleaning compositions comprise the inventive enzyme(s) and a biocide. “Biocides” are defined in more detail in paragraphs [0035] and [0036] of Reference RF1. These biocides also include compounds as defined in more detail in paragraphs [3006] and [3007] of Reference RF2. Biocides may include, without limitation, 2-phenoxyethanol and 4,4′-dichoro 2-hydroxydiphenylether.

Further adjunct cleaning additives are included and described in more detail in paragraphs [0005], [0006], [0019], [0028] to [0031] and [0037] to [0039] of Reference RF1.

### Preferred Cleaning Compositions

Preferably, the cleaning composition is a liquid cleaning composition comprising
a) a surfactant composition characterized in that the weight ratio of the total amount of all non-ionic surfactants (NIO) to the total amount of all surfactants in the cleaning composition is equal or below 0.88 times the weight ratio of the total amount of all alkyl benzene sulfonates (AS) to the total amount of all surfactants in the cleaning composition minus 0.1, and
b) a mannanase variant comprising
   b1) one or more amino acid substitutions at positions selected from the group consisting of 59, 66, 89, 234, 259, 282, 318, 319, and 322, according to the numbering of SEQ ID NO: 1, and an amino acid sequence which is at least 65%, preferably at least 70%, but less than 100% identical to SEQ ID NO: 1, or
   b2) one or more amino acid substitutions at positions selected from the group consisting of 59, 66, 89, 234, 259, and 282, according to the numbering of SEQ ID NO: 1, and an amino acid sequence which is at least 65%, preferably at least 70%, but less than 100% identical to amino acids 1-296 of SEQ ID NO: 1.

For clarification, as an amount of a component in the cleaning composition cannot be negative, preferably, the weight ratio of the total amount of all AS to the total amount of all surfactants in the cleaning composition is greater 0.1136. Preferably the liquid cleaning composition is a laundry or hard surface cleaning composition, preferably a liquid laundry cleaning composition, preferably an aqueous liquid laundry composition.

Preferably, the total amount of all non-aqueous solvents in the cleaning composition is 0-10 weight %, preferably 2-8 weight %.

Preferably, the cleaning composition comprises a surfactant composition characterized in that the weight ratio of the total amount of all non-ionic surfactants (NIO) in the cleaning composition to the total amount of all surfactants in the cleaning composition is equal or below 0.88 times the weight ratio of the total amount of all linear alkyl benzene sulfonates (LAS) to the total amount of all surfactants in the cleaning composition minus 0.1, wherein preferably the weight ratio of the total amount of all AS to the total amount of all surfactants in the cleaning composition is greater 0.1136.

Preferably, the surfactant composition comprises at least one anionic surfactant as described herein, preferably at least one alkylbenzene sulfonates (AS) and/or at least one AES. Preferably, the surfactant composition comprises at least one AS. In one embodiment, the surfactant composition comprises at least one NIO as described herein, preferably at least one alcohol ethoxylate (AEO). In one embodiment, the surfactant composition comprises at least one anionic surfactant as described herein and at least one NIO as described herein.

In one embodiment, the cleaning composition comprises one or more AES. In one embodiment, the surfactant composition comprises one or more AS as described herein and one or more AES as described herein.

In one embodiment, In one embodiment, the surfactant composition comprises at least one NIO as described herein. Preferably, the surfactant composition comprises at least one NIO as described herein and at least one AS as described herein. In one embodiment, the surfactant composition comprises at least one NIO as described herein and at least AES as described herein. In one embodiment, the surfactant composition comprises or consists of at least one NIO as described herein, at least one AS, and at least AES as described herein.

In one embodiment, the cleaning composition comprises at least one soap, preferably a salt of a coco-fatty acid as described herein. In one embodiment, the cleaning composition comprises at least one NIO as described herein and at least one soap, preferably a salt of a coco-fatty acid as described herein. In one embodiment, the cleaning composition comprises at least one NIO as described herein, at least one AS, and at least one soap, preferably a salt of a coco-fatty acid as described herein. In one embodiment, the surfactant composition comprises at least one NIO as described herein, at least one AES, and at least one soap, preferably a salt of a coco-fatty acid as described herein. In one embodiment, the cleaning composition comprises or consists of at least one NIO as described herein, at least one AS, at least one AES, and preferably at least one soap, preferably a salt of a coco-fatty acid as described herein, preferably with C12-C18, as described herein.

Preferably, the surfactant composition is characterized in that the weight ratio of the total amount of all AES in the cleaning composition to the total amount of all surfactants in the cleaning composition is the result of subtracting the weight ratio of the total amount of all NIO in the cleaning composition to the total amount of all surfactants in the cleaning composition and the weight ratio of the total amount of all AS in the cleaning composition to the total amount of all surfactants in the cleaning composition from 1, i.e., the weight ratio of the total amount of all AES in the cleaning composition to the total amount of all surfactants in the cleaning composition is 1 minus the weight ratio of the total amount of all NIO in the cleaning composition to the total amount of all surfactants in the cleaning composition and minus the weight ratio of the total amount of all AS in the cleaning composition to the total amount of all surfactants in the cleaning composition (i.e., [AES]=1−[NIO]−[AS]).

Preferably, the surfactant composition is characterized in that the weight ratio of the total amount of all AES in the cleaning composition to the total amount of all surfactants in the cleaning composition is the result of subtracting the weight ratio of the total amount of all NIO in the cleaning composition to the total amount of all surfactants in the cleaning composition and the weight ratio of the total amount of all LAS in the cleaning composition to the total amount of all surfactants in the cleaning composition from 1, i.e., the weight ratio of the total amount of all AES in the cleaning composition to the total amount of all surfactants in the cleaning composition is 1 minus the weight ratio of the total amount of all NIO in the cleaning composition to the total amount of all surfactants in the cleaning composition and minus the weight ratio of the total amount of all LAS in the cleaning composition to the total amount of all surfactants in the cleaning composition (i.e., [AES]=1−[NIO]−[LAS]).

Preferably, the surfactant composition is characterized in that the sum of the weight ratio of the total amount of all NIO in the cleaning composition to the total amount of all surfactants in the cleaning composition and the weight ratio of the total amount of all AS in cleaning composition to the total amount of all surfactants in the cleaning composition is below 1 (i.e., [NIO]+[AS]<1).

Preferably, the surfactant composition is characterized in that the sum of the weight ratio of the total amount of all NIO in the cleaning composition to the total amount of all surfactants in the cleaning composition and the weight ratio of the total amount of all LAS in cleaning composition to the total amount of all surfactants in the cleaning composition is below 1 (i.e., [NIO]+[LAS]<1).

Preferably, the total amount of all surfactants in the cleaning composition is 3-35 weight %, preferably 5-30 weight %, more preferably 10-25 weight %, most preferably 15-20 weight %.

Preferably, the total amount of all AS in the cleaning composition is 0.33-22 weight %, preferably 2-20 weight %, more preferably 2-18 weight %, most preferably 3-18 weight %.

Preferably, the total amount of all AES in the cleaning composition is 0-34.67 weight % or 1-34.67 weight %, preferably 0-25 weight %, more preferably 0-20 weight % or preferably 1-20 weight %.

Preferably, the total amount of all NIO in the cleaning composition is 0-27.3 weight % or 1-27.3 weight %, preferably 0-20 weight %, more preferably 0-15 weight % or preferably 1-15 weight %.

Preferably, the total amount of mannanase in the cleaning composition is 0.000025-0.002 weight %, preferably 0.00025-0.0008 weight %.

Preferably, the total amount of protease in the cleaning composition is 0-0.075 weight %, 0.005-0.075 weight %, or preferably 0.01-0.06 weight %.

Preferably, the total amount of amylase in the cleaning composition is 0-0.08 weight %, preferably 0.01-0.06 weight %.

Preferably, the total amount of all builders in the cleaning composition is 0.1-9 weight %, preferably 0.1-7 weight %, 1-7 weight %, 1-6 weight %, 2-6 weight %, 2-4 weight %, or preferably 2.5-3.5 weight %.

Preferably, the total amount of weak builder in the cleaning composition is 0.1-9 weight %, preferably 0.1-7 weight %, 1-6 weight %, 2-6 weight %, 2-4 weight %, or preferably 2.5-3.5 weight %.

Preferably, the total amount of strong builder in the cleaning composition is 0.0001-4.5 weight %, preferably 0.001-0.3 weight %.

Preferably, the ratio between the total amount of all weak builders and the total amount of all strong builders is 1.0:0.001 to 1.0:0.5, preferably 1.0:0.005 to 1.0:0.2.

Preferably, the cleaning composition is a liquid cleaning composition comprising
a) a surfactant composition characterized in that the weight ratio of the total amount of all non-ionic surfactants (NIO) in the cleaning composition to the total amount of all surfactants in the cleaning composition is equal or below 0.88 times the weight ratio of the total amount of all alkyl benzene sulfonates (AS) to the total amount of all surfactants in the cleaning composition minus 0.1, wherein preferably the weight ratio of the total amount of all AS to the total amount of all surfactants in the cleaning composition is greater 0.1136, and
b) a mannanase variant comprising
   b1) one or more amino acid substitutions at positions selected from the group consisting of X59V, X66D, X89H, X234Q, X259M, X282Y, X318N, X319G, and X322G, according to the numbering of SEQ ID NO: 11, and an amino acid sequence which is at least 80%, but less than 100% identical to SEQ ID NO: 11, or
   b2) one or more amino acid substitutions at positions selected from the group consisting of X59V, X66D, X89H, X234Q, X259M, and X282Y, according to the numbering of SEQ ID NO: 11, and an amino acid sequence which is at least 80%, but less than 100% identical to amino acids 1-296 of SEQ ID NO: 11,
wherein the cleaning composition preferably comprises one or more alcohol ethoxylate (AEO) and preferably one or more anionic surfactant, preferably selected from the group consisting of alkyl benzene sulfonate (AS) and alkyl ether sulfates (AES), preferably wherein the cleaning composition preferably comprises one or more alkyl benzene sulfonate (AS).

Preferably, the cleaning composition is a liquid cleaning composition comprising
a) a surfactant composition characterized in that the weight ratio of the total amount of all non-ionic surfactants (NIO) in the cleaning composition to the total amount of all surfactants in the cleaning composition is equal or below 0.88 times the weight ratio of the total amount of all linear alkyl benzene sulfonates (LAS) to the total amount of all surfactants in the cleaning composition minus 0.1, wherein preferably the weight ratio of the total amount of all AS to the total amount of all surfactants in the cleaning composition is greater 0.1136, and
b) a mannanase variant comprising
   b1) one or more amino acid substitutions at positions selected from the group consisting of X59V, X66D, X89H, X234Q, X259M, X282Y, X318N, X319G, and X322G, according to the numbering of SEQ ID NO: 11, and an amino acid sequence which is at least 80%, but less than 100% identical to SEQ ID NO: 11, or
   b2) one or more amino acid substitutions at positions selected from the group consisting of X59V, X66D, X89H, X234Q, X259M, and X282Y, according to the numbering of SEQ ID NO: 11, and an amino acid sequence which is at least 80%, but less than 100% identical to amino acids 1-296 of SEQ ID NO: 11,
wherein the cleaning composition preferably comprises one or more alcohol ethoxylate (AEO) and preferably one or more anionic surfactant, preferably selected from the group consisting of alkyl benzene sulfonate (AS) and alkyl ether sulfates (AES), preferably wherein the cleaning composition preferably comprises one or more alkyl benzene sulfonate (AS).

Preferably, the cleaning composition is a liquid cleaning composition comprising
a) a surfactant composition characterized in that the weight ratio of the total amount of all non-ionic surfactants (NIO) to the total amount of all surfactants in the cleaning composition is equal or below 0.88 times the weight ratio of the total amount of all alkyl benzene sulfonates (AS) to the total amount of all surfactants in the cleaning composition minus 0.1, wherein preferably the weight ratio of the total amount of all AS to the total amount of all surfactants in the cleaning composition is greater 0.1136, and
b) a mannanase variant comprising
   b1) one or more amino acid substitutions at positions selected from the group consisting of X59V, X66D, X89H, X234Q, X259M, X282Y, X318N, X319G, and X322G, according to the numbering of SEQ ID NO: 12, and an amino acid sequence which is at least 80% identical to SEQ ID NO: 12, or
   b2) one or more amino acid substitutions at positions selected from the group consisting of X59V, X66D, X89H, X234Q, X259M, and X282Y, according to the numbering of SEQ ID NO: 12, and an amino acid sequence which is at least 80% identical to amino acids 1-296 of SEQ ID NO: 12,
wherein the cleaning composition preferably comprises one or more alcohol ethoxylate (AEO) and preferably one or more anionic surfactant, preferably selected from the group consisting of alkyl benzene sulfonate (AS), (preferably, the AS being a mixture of LAS and BAS) and alkyl ether sulfates (AES), preferably, one or more AS being a mixture of LAS and BAS, preferably
wherein the cleaning composition comprises a protease as described herein, preferably further comprising an amylase as described herein.

Preferably, the cleaning composition comprises one or more surfactant selected from the group consisting of one or more AEO, one or more AS, and one or more AES, wherein preferably the AEO is an ethoxylated C10-C18 alcohol, preferably oxoalcohol, preferably C13-C15-oxoalcohol, preferably with 6-8 EO, wherein preferably the AS is a C9-C20 linear alkyl benzene sulfonate, preferably C10-C13 linear alkyl benzene sulfonate, and wherein preferably the AES is a C12-C15 alcohol ether sulfate, linear or branched, preferably with 1-3 EO.

Preferably, the cleaning composition comprises one or more builder, preferably one or more weak builder and/or one or more strong builder. Preferably, the weak builder comprises or consists of citrate and the strong builder is selected from the group consisting of MGDA, DTPMP, and EDDS, preferably the strong builder comprises or consists of DTPMP.

Preferably, the cleaning composition comprises one or more soap, preferably one or more coco-fatty acid, preferably one or more C12-C18 coco-fatty acid. Preferably, the total amount of all soap in the cleaning composition is 0-10 weight %, preferably 0.5-8 weight %, more preferably 1-5 weight %.

Preferably, the cleaning composition comprises an enzyme stabilizing system, preferably comprising or consisting of a tripeptide aldehyde and 1,2-propanediol.

Preferably, the liquid cleaning composition comprises
a) a surfactant composition characterized in that the weight ratio of the total amount of all non-ionic surfactants (NIO) to the total amount of all surfactants in the cleaning composition is equal or below 0.88 times the weight ratio of the total amount of all alkyl benzene sulfonates (AS) to the total amount of all surfactants in the cleaning composition minus 0.1, wherein preferably the weight ratio of the total amount of all AS to the total amount of all surfactants in the cleaning composition is greater 0.1136,
   I. wherein the total amount of all surfactants in the cleaning composition is 5-35 weight %, preferably 5-30 weight %, more preferably 10-25 weight %, most preferably 15-20 weight %,
   II. wherein the total amount of all AS in the cleaning composition is 0.33-22 weight %, preferably 2-20 weight %, more preferably 2-18 weight %, most preferably 3-18 weight %,
   III. wherein the total amount of all AES in the cleaning composition is 0-34.67 weight % or 1-34.67 weight %, preferably 0-25 weight %, more preferably 0-20 weight % or preferably 1-20 weight %, and
   IV. wherein the total amount of all NIO in the cleaning composition is 0-27.3 weight % or 1-27.3 weight %, preferably 0-20 weight %, more preferably 0-15 weight % or preferably 1-15 weight %,
b) optionally a builder composition, preferably comprising one or more weak builder and one or more strong builder,
   I. wherein the total amount of all builders in the cleaning composition is 0.1-9 weight %, preferably 0.1-7 weight %, 1-7 weight %, 1-6 weight %, 2-6 weight %, 2-4 weight %, or preferably 2.5-3.5 weight %,
   II. wherein the total amount of weak builder in the cleaning composition is 0.1-9 weight %, preferably 0.1-7 weight %, 1-6 weight %, 2-6 weight %, 2-4 weight %, or preferably 2.5-3.5 weight %, and
   III. wherein the total amount of strong builder in the cleaning composition is 0.0001-4.5 weight %, preferably 0.001-0.3 weight %, and
c) a mannanase variant, preferably in an amount of 0.000025-0.002 weight %, comprising at least one amino acid substitution selected from the group consisting of X59V, X66D, X89H, X234Q, X259M, X282Y, X318N, X319G, and X322G according to the numbering of SEQ ID NO: 11 and an amino acid sequence which is at least 80%, at least 85%, at least 90%, preferably at least 91%, at least 92%, at least 93%, at least 94%, at least 95%, at least 96%, at least 97%, or even more preferably at least 98% but less than 100% identical SEQ ID NO: 11, or
   wherein the mannanase variant comprises at least one amino acid substitution selected from the group consisting of X59V, X66D, X89H, X234Q, X259M, and X282Y according to the numbering of SEQ ID NO: 11 and an amino acid sequence which is at least 80%, at least 85%, at least 90%, preferably at least 91%, at least 92%, at least 93%, at least 94%, at least 95%, at least 96%, at least 97%, or even more preferably at least 98% but less than 100% identical to amino acids 1-296 of SEQ ID NO: 11.

Preferably, the liquid cleaning composition comprises
a) a surfactant composition characterized in that the weight ratio of the total amount of all non-ionic surfactants (NIO) to the total amount of all surfactants in the cleaning composition is equal or below 0.88 times the weight ratio of the total amount of all alkyl benzene sulfonates (AS) to the total amount of all surfactants in the cleaning composition minus 0.1, wherein preferably the weight ratio of the total amount of all AS to the total amount of all surfactants in the cleaning composition is greater 0.1136,
   I. wherein the total amount of all surfactants in the cleaning composition is 5-35 weight %, preferably 5-30 weight %, more preferably 10-25 weight %, most preferably 15-20 weight %,
   II. wherein the total amount of all AS in the cleaning composition is 0.33-22 weight %, preferably 2-20 weight %, more preferably 2-18 weight %, most preferably 3-18 weight %,
   III. wherein the total amount of all AES in the cleaning composition is 0-34.67 weight % or 1-34.67 weight %, preferably 0-25 weight %, more preferably 0-20 weight % or preferably 1-20 weight %, and
   IV. wherein the total amount of all NIO, preferably AEO, in the cleaning composition is 0-27.3 weight % or 1-27.3 weight %, preferably 0-20 weight %, more preferably 0-15 weight % or preferably 1-15 weight %,
b) optionally a builder composition, preferably comprising citrate and one or more builder selected from the group consisting of MGDA, DTPMP, and EDDS,
   I. wherein the total amount of all builders in the cleaning composition is 0.1-9 weight %, preferably 0.1-7 weight %, 1-7 weight %, 1-6 weight %, 2-6 weight %, 2-4 weight %, or preferably 2.5-3.5 weight %,
   II. wherein the total amount of citrate in the cleaning composition is 0.1-9 weight %, preferably 0.1-7 weight %, 1-6 weight %, 2-6 weight %, 2-4 weight %, or preferably 2.5-3.5 weight %, and
   III. wherein the total amount of all builders selected from the group consisting of MGDA, DTPMP, and EDDS in the cleaning composition is 0.0001-4.5 weight %, preferably 0.001-0.3 weight %, and
c) a mannanase variant, preferably in an amount of 0.000025-0.002 weight %, comprising at least one amino acid substitution selected from the group consisting of X59V, X66D, X89H, X234Q, X259M, X282Y, X318N, X319G, and X322G according to the numbering of SEQ ID NO: 11 and an amino acid sequence which is at least 80%, at least 85%, at least 90%, preferably at least 91%, at least 92%, at least 93%, at least 94%, at least 95%, at least 96%, at least 97%, or even more preferably at least 98% but less than 100% identical SEQ ID NO: 11, or
   wherein the mannanase variant comprises at least one amino acid substitution selected from the group consisting of X59V, X66D, X89H, X234Q, X259M, and X282Y according to the numbering of SEQ ID NO: 11 and an amino acid sequence which is at least 80%, at least 85%, at least 90%, preferably at least 91%, at least 92%, at least 93%, at least 94%, at least 95%, at least 96%, at least 97%, or even more preferably at least 98% but less than 100% identical to amino acids 1-296 of SEQ ID NO: 11, and
d) optionally a protease and/or an amylase.

Preferably, the liquid cleaning composition comprises
a) a surfactant composition characterized in that the weight ratio of the total amount of all non-ionic surfactants (NIO) to the total amount of all surfactants in the cleaning composition is equal or below 0.88 times the weight ratio of the total amount of all alkyl benzene sulfonates (AS) to the total amount of all surfactants in the cleaning composition minus 0.1, wherein preferably the weight ratio of the total amount of all AS to the total amount of all surfactants in the cleaning composition is greater 0.1136,
   I. wherein the total amount of all surfactants in the cleaning composition is 5-35 weight %, preferably 5-30 weight %, more preferably 10-25 weight %, most preferably 15-20 weight %,
   II. wherein the total amount of all AS, preferably C9-C20 linear and/or branched alkyl benzene sulfonate, preferably a mixture of C10-C13 linear and branched alkyl benzene sulfonate, in the cleaning composition is 0.33-22 weight %, preferably 2-20 weight %, more preferably 2-18 weight %, most preferably 3-18 weight %,
   III. wherein the total amount of all AES, preferably C12-C15 alcohol ether sulfate, linear or branched, preferably with 1-3 EO, in the cleaning composition is 1-34.67 weight %, preferably 1-20 weight %, and
   IV. wherein the total amount of all NIO, preferably ethoxylated C10-C18 alcohol, preferably oxoalcohol, preferably C13-C15-oxoalcohol, preferably with 6-8 EO, in the cleaning composition is 1-27.3 weight %, preferably 1-15 weight %,
b) optionally a builder composition, preferably comprising citrate and one or more builder selected from the group consisting of MGDA, DTPMP, and EDDS,
   I. wherein the total amount of all builders in the cleaning composition is 0.1-9 weight %, preferably 0.1-7 weight %, 1-7 weight %, 1-6 weight %, 2-6 weight %, 2-4 weight %, or preferably 2.5-3.5 weight %,
   II. wherein the total amount of citrate in the cleaning composition is 0.1-9 weight %, preferably 0.1-7 weight %, 1-6 weight %, 2-6 weight %, 2-4 weight %, or preferably 2.5-3.5 weight %, and
   III. wherein the total amount of all builders selected from the group consisting of MGDA, DTPMP, and EDDS in the cleaning composition is 0.0001-4.5 weight %, preferably 0.001-0.3 weight %, and
c) a mannanase variant, preferably in an amount of 0.000025-0.002 weight %, comprising at least one amino acid substitution selected from the group consisting of X59V, X66D, X89H, X234Q, X259M, X282Y, X318N, X319G, and X322G according to the numbering of SEQ ID NO: 11 and an amino acid sequence which is at least 80%, at least 85%, at least 90%, preferably at least 91%, at least 92%, at least 93%, at least 94%, at least 95%, at least 96%, at least 97%, or even more preferably at least 98% but less than 100% identical SEQ ID NO: 11, or
   wherein the mannanase variant comprises at least one amino acid substitution selected from the group consisting of X59V, X66D, X89H, X234Q, X259M, and X282Y according to the numbering of SEQ ID NO: 11 and an amino acid sequence which is at least 80%, at least 85%, at least 90%, preferably at least 91%, at least 92%, at least 93%, at least 94%, at least 95%, at least 96%, at least 97%, or even more preferably at least 98% but less than 100% identical to amino acids 1-296 of SEQ ID NO: 11,
d) optionally a protease and/or an amylase,
e) 0-10 weight %, preferably 0.5-8 weight %, more preferably 1-5 weight % of soap, preferably one or more coco-fatty acid, preferably one or more C12-C18 coco-fatty acid,
preferably, wherein the total amount of all non-aqueous solvents in the cleaning composition is 0-10 weight %, preferably 2-8 weight %.

### Method of Making

The present invention also relates to a method for making a cleaning composition comprising the steps of mixing
a) a mannanase as described herein; and
b) a surfactant composition as described herein.

The present invention also refers to a method for making a cleaning composition with improved protease stability and/or for providing a cleaning composition with improved wash performance comprising the steps of mixing
a) a mannanase as described herein; and
b) a surfactant composition as described herein.

In one embodiment, the present invention is directed to a method for providing a cleaning composition with improved storage stability and/or wash performance of a protease in the cleaning composition, comprising the steps of mixing
a) a surfactant composition characterized in that the weight ratio of the total amount of all non-ionic surfactants (NIO) to the total amount of all surfactants in the cleaning composition is equal or below 0.88 times the weight ratio of the total amount of all alkyl benzene sulfonates (AS) to the total amount of all surfactants in the cleaning composition minus 0.1, wherein preferably the weight ratio of the total amount of all AS to the total amount of all surfactants in the cleaning composition is greater 0.1136, and
b) a mannanase variant comprising
   b1) one or more amino acid substitutions at positions selected from the group consisting of 59, 66, 89, 234, 259, 282, 318, 319, and 322, according to the numbering of SEQ ID NO: 11, and an amino acid sequence which is at least 65%, preferably at least 70%, but less than 100% identical to SEQ ID NO: 11, or
   b2) one or more amino acid substitutions at positions selected from the group consisting of 59, 66, 89, 234, 259, and 282, according to the numbering of SEQ ID NO: 11, and an amino acid sequence which is at least 65%, preferably at least 70%, but less than 100% identical to amino acids 1-296 of SEQ ID NO: 11.

The cleaning compositions described herein may be in any form of a liquid cleaning composition. Preferably, the cleaning composition is a liquid laundry cleaning composition. Preferably, the cleaning composition is an aqueous liquid laundry cleaning composition.

### Method of Use

The cleaning composition described herein can be used in various cleaning applications.

Preferably, the cleaning composition described herein is used in laundry or hard surface cleaning, preferably for home care or |&| cleaning. The cleaning composition described herein may be used in various industrial and institutional cleaning applications, including commercial laundry such as on premise laundry or tunnelwashing, mechanical ware wash such as in a hood machine or in a tunnelwasher, manual dish wash cleaning, carpet cleaning, open plant cleaning (outside pipe cleaning), cleaning in place (inside pipe cleaning), membrane cleaning such as in dairy, food, beverage or water treatment, vehicle care such as pad cleaning, microorganism removal, virus removal, insect removal or malodor removal or veterinary cleaning.

Preferably, the cleaning composition described herein is used for laundry cleaning.

In one embodiment, the cleaning composition described herein is used for providing an improved wash performance of the cleaning composition, preferably after storage of the cleaning composition, preferably after storage of the cleaning composition at a temperature of 15° C., 30° C., 37° C., 45° C., or 50° C. for 14, 28, 56, or 86 days, preferably at 37° C. for 56 days, preferably compared to a cleaning composition comprising a different mannanase and/or compared to a cleaning composition comprising a different surfactant composition.

In a further embodiment, the cleaning composition described herein is used for providing an improved storage stability of a protease in the cleaning composition, preferably after storage of the cleaning composition, preferably after storage of the cleaning composition at a temperature of 15° C., 30° C., 37° C., 45° C., or 50° C. for 14, 28, 56, or 86 days, preferably at 37° C. for 56 days, preferably compared to a cleaning composition comprising a different mannanase and/or compared to a cleaning composition comprising a different surfactant composition.

Thus, one embodiment is directed to the use of a liquid cleaning composition comprising
a) a surfactant composition characterized in that the weight ratio of the total amount of all non-ionic surfactants (NIO) to the total amount of all surfactants in the cleaning composition is equal or below 0.88 times the weight ratio of the total amount of all alkyl benzene sulfonates (AS) to the total amount of all surfactants in the cleaning composition minus 0.1, wherein preferably the weight ratio of the total amount of all AS to the total amount of all surfactants in the cleaning composition is greater 0.1136, and
d) a mannanase variant comprising
   b1) one or more amino acid substitutions at positions selected from the group consisting of 59, 66, 89, 234, 259, 282, 318, 319, and 322, according to the numbering of SEQ ID NO: 11, and an amino acid sequence which is at least 65%, preferably at least 70%, but less than 100% identical to SEQ ID NO: 11, or
   b2) one or more amino acid substitutions at positions selected from the group consisting of 59, 66, 89, 234, 259, and 282, according to the numbering of SEQ ID NO: 11, and an amino acid sequence which is at least 65%, preferably at least 70%, but less than 100% identical to amino acids 1-296 of SEQ ID NO: 11.
for improving the storage stability of the mannanase variant in the cleaning composition and/or for improving the wash performance of the cleaning composition after storage.

While the invention has been illustrated and described in detail in the drawings and foregoing description, such illustration and description are to be considered illustrative or exemplary and not restrictive. The invention is not limited to the disclosed embodiments. Other variations to the disclosed embodiments can be understood and effected by those skilled in the art in practicing a claimed invention, from a study of the drawings, the disclosure, and the dependent claims. The detailed description is merely exemplary in nature and is not intended to limit application and uses. The following examples further illustrate the present invention without, however, limiting the scope of the invention thereto. Various changes and modifications can be made by those skilled in the art on the basis of the description of the invention, and such changes and modifications are also included in the present invention.

### EXAMPLES

### Material and Methods

Mannanase wash performance was determined after storage in various detergent formulations.

The tested detergent formulations were prepared with the listed ingredients (1)-(12) according to the following procedure. Ingredient (3), (6) and (12) were filled into a beaker and heated to 50-55° C. While stirring with a blade stirrer at around 120 rpm ingredient (4), which was preheated and homogenized, was slowly added. Sodium hydroxide was added for adjusting the pH value to pH 7.5 until the solution was clear and homogenous. Ingredient (2) was added and stirred until the formulation was homogenous. Heating was turned off and ingredients (1), (5), (7), and (8) were added when temperature was below 30° C. The pH value was adjusted using sodium hydroxide to pH 8.0.

Subsequently, mannanase (9), protease (10), and amylase (11) were added to the individual formulations.

The mannanase used was either
Mannanase A (invention): SEQ ID NO: 12
Mannanase B (reference): SEQ ID NO: 13

The protease used was a protease with an amino acid sequence as shown in SEQ ID NO: 3 comprising a tripeptide aldehyde protease inhibitor.

The amylase used was an amylase with an amino acid sequence set forth in SEQ ID NO: 14 with the amino acid substitutions G4Q+N25H+G176K+G186E+T251E+L405M+Y482W according to the numbering of SEQ ID NO: 15.

The formulations were stored at 37° C. for 56 days. Samples were taken at day 0 and 56.

Four unwashed soiled swatches (2×C-S-43, Guargum, 2×C-S-73, Locustbeangum; obtained from CFT, Vlaardingen, Netherlands) were washed with steel balls in wash liquor containing the above formulations after storage in the launder-o-meter (ratio height to diameter 1:1.5, size <2000 mL, filling rate <80%) under the washing conditions shown in Table 2.

TABLE 1
Ingredient
concentration

| in weight % | Formulation Number | | | | | | | | | | | | | |
|---|---|---|---|---|---|---|---|---|---|---|---|---|---|---|
| active | F1 | F2 | F3 | F4 | F5 | F6 | F7 | F8 | F9 | F10 | F11 | F12 | F13 | F14 |
| (1) AEO | 1.8 | 5 | 8.3 | 14.8 | 8.3 | 0 | 0 | 0 | 0 | 5.4 | 4.5 | 1.8 | 1.8 | 1.8 |
| (2) AES | 13 | 6.4 | 9.7 | 3.2 | 0 | 15.3 | 8.3 | 6.3 | 10.8 | 0 | 0 | 7.6 | 6.5 | 3.2 |
| (3) AS | 3.2 | 6.4 | 0 | 0 | 9.7 | 2.7 | 9.7 | 11.7 | 7.2 | 12.6 | 13.5 | 8.6 | 9.7 | 13.0 |
| (4) Coco- | 2 | 2 | 2 | 2 | 2 | 2 | 2 | 2 | 2 | 2 | 2 | 2 | 2 | 2 |
| fatty acid | | | | | | | | | | | | | | |
| (5) | 3 | 3 | 3 | 3 | 3 | 3 | 3 | 3 | 3 | 3 | 3 | 3 | 3 | 3 |
| Sodium | | | | | | | | | | | | | | |
| citrate | | | | | | | | | | | | | | |
| (6) 1,2- | 6 | 6 | 6 | 6 | 6 | 6 | 6 | 6 | 6 | 6 | 6 | 6 | 6 | 6 |
| Propanediol | | | | | | | | | | | | | | |
| (7) | 0.12 | 0.12 | 0.12 | 0.12 | 0.12 | 0.12 | 0.12 | 0.12 | 0.12 | 0.12 | 0.12 | 0.12 | 0.12 | 0.12 |
| DTPMP | | | | | | | | | | | | | | |
| (8) | 1 | 1 | 1 | 1 | 1 | 1 | 1 | 1 | 1 | 1 | 1 | 1 | 1 | 1 |
| Ethanol | | | | | | | | | | | | | | |
| (9) | 0.0006 | 0.0006 | 0.0006 | 0.0006 | 0.0006 | 0.0006 | 0.0006 | 0.0006 | 0.0006 | 0.0006 | 0.0006 | 0.0006 | 0.0006 | 0.0006 |
| Mannanase | | | | | | | | | | | | | | |
| (10) | 0.04 | 0.04 | 0.04 | 0.04 | 0.04 | 0.04 | 0.04 | 0.04 | 0.04 | 0.04 | 0.04 | 0.04 | 0.04 | 0.04 |
| Protease | | | | | | | | | | | | | | |
| (11) | 0.004 | 0.004 | 0.004 | 0.004 | 0.004 | 0.004 | 0.004 | 0.004 | 0.004 | 0.004 | 0.004 | 0.004 | 0.004 | 0.004 |
| Amylase | | | | | | | | | | | | | | |
| (12) | Up | Up | Up | Up | Up | Up | Up | Up | Up | Up | Up | Up | Up | Up |
| Deionized | to | to | to | to | to | to | to | to | to | to | to | to | to | to |
| Water | 100% | 100% | 100% | 100% | 100% | 100% | 100% | 100% | 100% | 100% | 100% | 100% | 100% | 100% |

(1): AEO: C13-C15-oxoalcohol (7 EO) (Lutensol AO 7, BASF)
(2): AES: sodium laureth-2-sulfate = C12-C14 fatty alcohol ether sulfate (2 EO), sodium salt (Texapon N 70, BASF)
(3): AS: alkylbenzylsulfonic acid, alkyl = C10-C13, linear (Maranil DBS/LC, BASF)
(4): Coco fatty acid, C12-C18, C18 unsaturated (Edenor K 12-18, Edenor Technology Sdn Bhd)

Formulations F6, F7, F8, F9, F10, F11, F12, F13, and F14 are formulations according to the present invention.

Formulations F1, F2, F3, F4, and F5 are reference formulations.

TABLE 2
Wash conditions

| Water | 250 | mL |
|---|---|---|
| Steel balls | 20 pieces with 6 mm diameter and 0.9 g | |
| Wash temperature | 30° | C. |
| Wash duration | 20 | min |
| Detergent dosing | 3 | g/L |
| Washing cycles | 1 | |
| Ballast fabric | 15 g cotton fabric 283 | |
| Sum ballast fabric + | 20 | g |
| soiled swatches | | |

| | |
|---|---|
| Water hardness | 2.5 mmol/L; Ca²⁺:Mg²⁺:HCO₃ = 4:1:8 |

After washing, the fabric swatches were rinsed, spin-dried and dried in the air. The wash performance for the single stains were determined as follows:

The achieved stain removal effect (ΔE) was determined by measuring reflectance values of the stains using a sphere reflectance spectrometer (SF500 type from Datacolor, USA, wavelength range 360-700 nm). With the aid of the CIE-Lab color space classification, the brightness L*, the value a* on the red-green color axis and the b* value on the yellow-blue color axis, was measured before and after washing. ΔE is calculated according to the following formula:

$$Δ {E}_{ab}^{*} = \sqrt{Δ {L}^{* 2} + Δ {a}^{* 2} + Δ {b}^{* 2}}$$

The results of the protease wash performance is shown in Table 3:

TABLE 3
Mannanase wash performance in launder-o-meter after storage at 37° C. for 56 days.

| | Superior | Wash performance | Wash performance | Remaining wash | Remaining wash |
|---|---|---|---|---|---|
| Formulation | performance | [in dE] for | [in dE] for | performance [%] | performance [%] |
| Number | of Mannanase A | Mannanase A | Mannanase B | Mannanase A | Mannanase B |
| F1 | No/Equal | 28.3 | 30.4 | 68.8 | 69.4 |
| F8 | Yes | 25.5 | 16.1 | 76.1 | 44.7 |
| F9 | Yes | 28.6 | 19.6 | 77.6 | 49.4 |
| F10 | Yes | 25.8 | 15.5 | 67.8 | 41.6 |
| F2 | No/Equal | 27.5 | 27.1 | 69.7 | 67.5 |
| F11 | Yes | 24.0 | 19.2 | 59.8 | 50.4 |
| F12 | Yes | 27.1 | 21.4 | 75.6 | 59.4 |
| F13 | Yes | 27.2 | 19.5 | 75.8 | 52.6 |
| F14 | Yes | 26.5 | 15.0 | 82.8 | 44.9 |
| F3 | No/Equal | 28.3 | 30.5 | 71.3 | 74.4 |
| F4 | No | 31.3 | 34.9 | 64.9 | 89.4 |
| F5 | No | 23.7 | 26.0 | 56.8 | 61.3 |
| F6 | Yes | 29.0 | 26.2 | 71.5 | 64.5 |
| F7 | Yes | 27.3 | 16.0 | 76.5 | 42.5 |

It can be derived from Table 3 that the Mannanase A (invention) compared to Mannanase B (reference) shows a better residual wash performance in formulations comprising the surfactant composition described herein (cf. F6, F7, F8, F9, F10, F11, F12, F13, and F14) compared to formulations with a different surfactant composition (cf. F1, F2, F3, F4, and F5).

1. A liquid cleaning composition comprising
a) a surfactant composition wherein the weight ratio of the total amount of all non-ionic surfactants (NIO) to the total amount of all surfactants in the cleaning composition is equal or below 0.88 times the weight ratio of the total amount of all alkyl benzene sulfonates (AS) to the total amount of all surfactants in the cleaning composition minus 0.1, wherein the weight ratio of the total amount of all AS to the total amount of all surfactants in the cleaning composition is greater 0.1136, and
b) a mannanase variant comprising
b1) one or more amino acid substitutions at positions selected from the group consisting of 59, 66, 89, 234, 259, 282, 318, 319, and 322, according to the numbering of SEQ ID NO: 11, and an amino acid sequence which is at least 70%, but less than 100% identical to SEQ ID NO: 11, or
b2) one or more amino acid substitutions at positions selected from the group consisting of 59, 66, 89, 234, 259, and 282, according to the numbering of SEQ ID NO: 11, and an amino acid sequence which is at least 70%, but less than 100% identical to amino acids 1-296 of SEQ ID NO: 11.

2. The cleaning composition of claim 1, wherein the mannanase variant comprises at least one amino acid substitution selected from the group consisting of X59V, X66D, X89H, X234Q, X259M, X282Y, X318N, X319G, and X322G according to the numbering of SEQ ID NO: 11 and an amino acid sequence which is at least 80%, at least 85%, at least 90%, at least 91%, at least 92%, at least 93%, at least 94%, at least 95%, at least 96%, at least 97%, or at least 98% but less than 100% identical SEQ ID NO: 11, or
wherein the mannanase variant comprises at least one amino acid substitution selected from the group consisting of X59V, X66D, X89H, X234Q, X259M, and X282Y according to the numbering of SEQ ID NO: 11 and an amino acid sequence which is at least 80%, at least 85%, at least 90%, at least 91%, at least 92%, at least 93%, at least 94%, at least 95%, at least 96%, at least 97%, at least 98% but less than 100% identical to amino acids 1-296 of SEQ ID NO: 11.

3. The cleaning composition of claim 1, wherein the surfactant composition comprises one or more anionic surfactant.

4. The cleaning composition of claim 1, wherein the surfactant composition comprises one or more NIO.

5. The cleaning composition of claim 1, wherein
a) the total amount of all surfactants in the cleaning composition is 3-35 weight %,
b) the total amount of all AS is 0.33-22 weight %,
c) the total amount of all AES is 0-34.67 weight %, and
d) the total amount of all NIO is 0-27.3 weight %.

6. The cleaning composition of claim 1, wherein the surfactant composition comprises or consists of one or more AS, one or more NIO, and one or more AES.

7. The cleaning composition of claim 1, wherein the weight ratio of the total amount of all AES to the total amount of all surfactants in the cleaning composition is the result of subtracting the weight ratio of the total amount of all NIO to the total amount of all surfactants in the cleaning composition and the weight ratio of the total amount of all AS to the total amount of all surfactants in the cleaning composition from 1.

8. The cleaning composition of claim 1, wherein the NIO is an ethoxylated C10-C18 alcohol, wherein the AS is a C9-C20 linear alkyl benzene sulfonate, and wherein the AES is a C12-C15 alcohol ether sulfate, linear or branched.

9. The cleaning composition of claim 1, wherein the cleaning composition comprises a builder composition.

10. The cleaning composition of claim 1, wherein the cleaning composition comprises an additional enzyme.

11. The cleaning composition of claim 1, wherein the cleaning composition comprises an enzyme stabilizing system.

12. The cleaning composition of claim 1, wherein the cleaning composition is a laundry cleaning composition or a hard surface cleaning composition.

13. A method for providing a cleaning composition with improved storage stability and/or wash performance, comprising the steps of mixing
a) a surfactant composition wherein the weight ratio of the total amount of all non-ionic surfactants (NIO) to the total amount of all surfactants in the cleaning composition is equal or below 0.88 times the weight ratio of the total amount of all alkyl benzene sulfonates (AS) to the total amount of all surfactants in the cleaning composition minus 0.1, wherein the weight ratio of the total amount of all AS to the total amount of all surfactants in the cleaning composition is greater 0.1136, and
b) a mannanase variant comprising
b1) one or more amino acid substitutions at positions selected from the group consisting of 59, 66, 89, 234, 259, 282, 318, 319, and 322, according to the numbering of SEQ ID NO: 11, and an amino acid sequence which is at least 70%, but less than 100% identical to SEQ ID NO: 11, or
b2) one or more amino acid substitutions at positions selected from the group consisting of 59, 66, 89, 234, 259, and 282, according to the numbering of SEQ ID NO: 11, and an amino acid sequence which is at least 70%, but less than 100% identical to amino acids 1-296 of SEQ ID NO: 11.

14. A method of using the cleaning composition according to claim 1, the method comprising using the cleaning composition for improving the storage stability of the mannanase variant in the cleaning composition.

15. A method of using the cleaning composition according to claim 1, the method comprising using the cleaning composition for improving the wash performance of the cleaning composition after storage.

16. The cleaning composition of claim 1, wherein the surfactant composition comprises one or more anionic surfactant selected from the group consisting of AS, alcohol alkyl ether sulfates (AES), and mixtures thereof.

17. The cleaning composition of claim 1, wherein the surfactant composition comprises one or more NIO, wherein the NIO is an alcohol ethoxylate (AEO).

18. The cleaning composition of claim 1, wherein the cleaning composition comprises a builder composition comprising a builder selected from the group consisting of citric acid, amino-tris-methylene-phosphonic acid (AMP), succinate, acetate, and salts thereof.

19. The cleaning composition of claim 1, wherein the cleaning composition comprises an additional enzyme selected from the group consisting of protease, amylases, lipases, mannanases other than the mannanase, cellulases, hemicellulases, phospholipases, esterases, pectinases, lactases, peroxidases, xylanases, cutinases, pectate lyases, keratinases, reductases, oxidases, phenoloxidases, lipoxy-genases, ligninases, pullulanases, tannases, pentosanases, malanases, beta-glucanases, arabinosidases, hyaluronidases, chondroitinases, laccases, nucleases, ribonucleases (RNAses), deoxyribonucleases (DNAses), phosphodiesterases, phytases, carbohydrases, galactanases, xanthanases, xyloglucanases, oxidoreductases, perhydrolases, aminopeptidases, asparaginases, carbohydrases, carboxypeptidases, catalases, chitinases, cyclodextrin glycosyltransferases, alpha-galactosidases, beta-galactosidases, glucoamylases, alpha-glucosidases, beta-glucosidases, invertases, transglutaminases, dispersins, and combinations of at least two of the foregoing types.

20. The cleaning composition of claim 1, wherein the cleaning composition comprises an enzyme stabilizing system, wherein the enzyme stabilizing system comprises at least one compound selected from the group consisting of polyols, inorganic salts, carboxylic acids having a C1-C3 chain or salts thereof, borate, boric acid, boronic acids, peptide aldehydes, peptide acetals, and peptide aldehyde hydrosulfite adducts.
